(19) United States
(12) Patent Application Publication
(10) Pub. No.: US 2026/0197915 A1
(43) Pub. Date: Jul. 9, 2026

(54) LED Current Overshoot Reduction Apparatus and Method

(71) Applicant: Diodes Incorporated, Plano, TX (US)

(72) Inventors: Dongjie Cheng, Plano, TX (US); Allan Ming-Lun Lin, Pleasanton, CA (US)

(21) Appl. No.: 19/550,836

(22) Filed: Feb. 26, 2026

Related U.S. Application Data
(63) Continuation-in-part of application No. 18/789,342, filed on Jul. 30, 2024, now Pat. No. 12,621,913.

(51) Int. Cl. H05B 45/54; H05B 45/325; H05B 45/397

(52) U.S. Cl. CPC H05B 45/54; H05B 45/325; H05B 45/397

(57) ABSTRACT

An apparatus includes a reference current generation circuit coupled between a first voltage bus and a second voltage bus, wherein the reference current generation circuit is configured to generate a predetermined reference current, a first reference current path comprising a first switch, wherein the predetermined reference current is configured to be mirrored to generate a first reference current in the first reference current path, a load current path comprising a power switch, and an overshoot reduction circuit configured to reduce an overshoot occurring at a leading-edge of a load current flowing through the power switch.

### PRIORITY CLAIM AND CROSS-REFERENCE

This application is a continuation-in-part of U.S. Patent Application No. 18/789,342, filed on July 30, 2024, which application is hereby incorporated herein by reference.

### TECHNICAL FIELD

The present disclosure relates generally to the field of integrated circuits, and in particular embodiments, to techniques and mechanisms for an LED current overshoot reduction apparatus.

### BACKGROUND

A light emitting diode (LED) is a semiconductor light source. When a voltage is applied to the LED, a current flows through the LED. In response to the current flowing through the LED, electrons and holes recombine in the PN Junction of the diode. In the recombination process, energy is released in the form of photons.

In a typical LED system, a power switch is connected in series with an LED between a power source and ground. A Pulse Width Modulation (PWM) controller is employed to control the power switch. In operation, the PWM controller is configured to generate a gate drive signal applied to a gate of the power switch. The gate drive signal is controlled such that an average current flowing through the LED is adjustable based on different operating requirements. This PWM technique for controlling the LED average current is widely used for controlling LED brightness.

Power PWM dimming is a technique used to control the brightness of an LED by varying the amount of time the LED is powered on and off. Instead of adjusting the voltage or current supplied to the LED, PWM dimming rapidly switches the LED on and off at a high frequency. The brightness is determined by the ratio of the on-time to the off-time within each cycle, known as the duty cycle.

In operation, when power PWM dimming is applied to an LED, the average power delivered to the LED over time controls the brightness. A higher duty cycle means the LED is on for a longer portion of each cycle, resulting in higher brightness. Conversely, a lower duty cycle means the LED is on for a shorter portion, resulting in dimmer light. Power PWM dimming is widely used in applications requiring precise and efficient control of LED brightness, such as in automotive lighting.

Accuracy and linearity are critical design specifications in power PWM dimming. Achieving desired dimming accuracy and linearity requires considering or minimizing the delay time between the PWM signal and the LED current response, particularly in high frequency PWM control. High frequency operation can cause LED current overshoot (inrush current) during PWM transitions, leading to dimming inaccuracies, nonlinearity, and undesired LED light flickers. Although LED flickers are generally not harmful to the eyes of most people, they can cause discomfort, eye strain, headaches, and visual disturbances in some individuals. It would be desirable to have a simple apparatus through which the LED current overshoot can be reduced. This disclosure describes a simple and cost-efficient apparatus for reducing the LED current overshoot, thereby developing high-quality LED lighting products without LED light flickers.

### SUMMARY

Technical advantages are generally achieved, by embodiments of this disclosure which describe an LED current overshoot reduction apparatus.

In accordance with an embodiment, an apparatus comprises a reference current generation circuit coupled between a first voltage bus and a second voltage bus, wherein the reference current generation circuit is configured to generate a predetermined reference current, a first reference current path comprising a first switch, wherein the predetermined reference current is configured to be mirrored to generate a first reference current in the first reference current path, a load current path comprising a power switch, and a pulse width modulation (PWM) deglitch circuit configured to control the first switch so as to reduce an overshoot occurring at a leading-edge of a load current flowing through the power switch.

In accordance with another embodiment, a method comprises generating a predetermined reference current using a reference current generation circuit coupled between a first voltage bus and a second voltage bus, mirroring the predetermined reference current to generate a first reference current in a first reference current path comprising a first switch, and controlling, by a PWM deglitch circuit, the first switch to reduce an overshoot occurring at a leading-edge of a load current flowing through a power switch.

In accordance with yet another embodiment, a system comprises a PWM switch, an integrated circuit and a light emitting diode connected in series between a power source and ground, and a system controller configured to control the PWM switch, wherein the integrated circuit comprises a low-dropout regulator having an input configured to receive an input voltage and an output configured to generate a bias voltage on a first voltage bus, an undervoltage lockout circuit configured to receive the bias voltage and generate a control signal applied to a gate of a power switch, wherein a current flowing through the power switch is approximately equal to a current flowing through the light emitting diode, a bandgap reference circuit configured to receive the bias voltage and generate a bandgap reference, a reference current generation circuit coupled between the first voltage bus and a second voltage bus, wherein the reference current generation circuit is configured to generate a predetermined reference current, a first reference current path comprising a first switch, wherein the predetermined reference current is configured to be mirrored to generate a first reference current in the first reference current path, and a PWM deglitch circuit configured to control the first switch so as to reduce an overshoot occurring at a leading-edge of a load current flowing through the power switch.

In accordance with an embodiment, an apparatus comprises a reference current generation circuit coupled between a first voltage bus and a second voltage bus, wherein the reference current generation circuit is configured to generate a predetermined reference current, a first reference current path comprising a first switch, wherein the predetermined reference current is configured to be mirrored to generate a first reference current in the first reference current path, a load current path comprising a power switch, and an overshoot reduction circuit configured to reduce an overshoot occurring at a leading-edge of a load current flowing through the power switch.

Optionally, in the preceding aspect, the power switch is configured to be coupled to a power source through a plurality of light emitting diodes connected in series.

Optionally, in any of the preceding aspects, the reference current generation circuit comprises a first p-type transistor and a resistor connected in series between the first voltage bus and the second voltage bus, and a first amplifier having an inverting input configured to receive a bandgap reference, a non-inverting input connected to a common node of the first p-type transistor and the resistor, and an output connected to a gate of the first p-type transistor, and the first reference current path comprises a second p-type transistor, the first switch and a first n-type transistor connected in series, and wherein the first p-type transistor and the second p-type transistor form a first current mirror through which the predetermined reference current is mirrored to generate the first reference current in the first reference current path, and wherein the first n-type transistor and a second n-type transistor form a second current mirror through which the first reference current is mirrored to generate the load current flowing through the power switch, and a gate of the first n-type transistor and a gate of the second n-type transistor are connected together and further connected to an output of a second amplifier having an inverting input connected to a drain of the first n-type transistor and a non-inverting input connected to a drain of the second n-type transistor, and wherein the power switch and the second n-type transistor are connected in series.

Optionally, in any of the preceding aspects, the overshoot reduction circuit comprises an undervoltage lockout unit, and wherein the undervoltage lockout unit is configured to receive a voltage on the drain of the second n-type transistor, and generate a signal to control the output of the second amplifier, and wherein the voltage on the drain of the second n-type transistor is compared with a predetermined reference, the output of the second amplifier is pulled down to a logic low state when the voltage on the drain of the second n-type transistor is less than the predetermined reference, and the logic low state at the output of the second amplifier is configured to reduce the overshoot occurring at the leading-edge of the load current flowing through the power switch.

Optionally, in any of the preceding aspects, the apparatus further comprises a pulse width modulation (PWM) deglitch circuit comprising a first inverter configured to receive a reference voltage signal proportional to the predetermined reference current, and a second inverter having an input connected to an output of the first inverter and an output configured to generate a first control signal applied to a gate of the first switch.

Optionally, in any of the preceding aspects, the apparatus further comprises a system controller configured to generate a PWM signal to control a PWM switch connected in series with the power switch, wherein the system controller and the PWM deglitch circuit are configured as the overshoot reduction circuit configured to reduce the overshoot occurring at the leading-edge of the load current flowing through the power switch.

Optionally, in any of the preceding aspects, the PWM deglitch circuit is configured to generate a deglitch time signal that removes a leading-edge portion of the load current flowing through the power switch, and based on the deglitch time signal, the system controller is configured to extend a trailing edge of the PWM signal to compensate for removal of the leading-edge portion of the load current.

Optionally, in any of the preceding aspects, the apparatus further comprises a system controller configured to generate a PWM signal to control a PWM switch connected in series with the power switch, wherein the system controller is configured as the overshoot reduction circuit configured to reduce the overshoot occurring at the leading-edge of the load current flowing through the power switch, and wherein the system controller is configured to detect removal of a leading-edge portion of the load current, and to extend a trailing edge of the PWM signal to compensate for the removal of the leading-edge portion of the load current.

Optionally, in any of the preceding aspects, the apparatus further comprises a low-dropout regulator having an input configured to receive an input voltage and an output configured to generate a bias voltage on the first voltage bus, an undervoltage lockout circuit configured to receive the bias voltage and generate a control signal applied to a gate of the power switch, and a bandgap reference circuit configured to receive the bias voltage, and generate a bandgap reference.

Optionally, in any of the preceding aspects, the apparatus further comprises a gate protection circuit connected between a gate of the power switch and the second voltage bus, wherein the gate protection circuit comprises a first resistor, a second resistor, a capacitor and a third n-type transistor, and wherein the third n-type transistor is connected between the gate of the power switch and the second voltage bus, the capacitor and the first resistor are connected in series between the gate of the power switch and the second voltage bus, and the second resistor is connected between the gate of the power switch and the second voltage bus.

Optionally, in any of the preceding aspects, the apparatus further comprises a startup circuit comprising a third current mirror comprising a fourth n-type transistor and a fifth n-type transistor, and a sixth p-type transistor, wherein the sixth p-type transistor and the fifth n-type transistor are connected in series between the first voltage bus and the second voltage bus, the power switch and the fourth n-type transistor are connected in series between a third voltage bus and the second voltage bus, and the predetermined reference current is configured to be mirrored to generate a current flowing through the sixth p-type transistor, and wherein the first voltage bus is configured to provide a bias voltage, and the third voltage bus is configured to provide a drive voltage for a plurality of light emitting diodes.

In accordance with another embodiment, a method comprises generating a predetermined reference current using a reference current generation circuit coupled between a first voltage bus and a second voltage bus, mirroring the predetermined reference current to generate a first reference current in a first reference current path comprising a first switch, and configuring an overshoot reduction circuit to reduce an overshoot occurring at a leading-edge of a load current flowing through a power switch.

Optionally, in the preceding aspect, the method further comprises mirroring the first reference current to generate the load current flowing through the power switch, wherein the overshoot reduction circuit comprises an undervoltage lockout unit, and wherein the undervoltage lockout unit is configured to reduce the overshoot occurring at the leading-edge of the load current flowing through the power switch.

Optionally, in any of the preceding aspects, the overshoot reduction circuit further comprises a second current mirror and a second amplifier, and wherein a PWM deglitch circuit comprises a first inverter configured to receive a reference voltage signal proportional to the predetermined reference current, and a second inverter having an input connected to an output of the first inverter and an output configured to generate a first control signal applied to a gate of the first switch, the reference current generation circuit comprises a first p-type transistor and a resistor connected in series between the first voltage bus and the second voltage bus, and a first amplifier having an inverting input configured to receive a bandgap reference, a non-inverting input connected to a common node of the first p-type transistor and the resistor, and an output connected to a gate of the first p-type transistor and a gate of a second p-type transistor, the first reference current path comprises the second p-type transistor and the first switch connected in series, and wherein the first p-type transistor and the second p-type transistor form a first current mirror through which the predetermined reference current is mirrored to generate the first reference current in the first reference current path, the second current mirror comprises a first n-type transistor connected in series with the first switch, and a second n-type transistor is connected in series with the power switch, wherein through the second current mirror, the first reference current is mirrored to generate the load current flowing through the power switch, and the second amplifier has an inverting input connected to a drain of the first n-type transistor, a non-inverting input connected to a drain of the second n-type transistor, and an output connected to a gate of the first n-type transistor and a gate of the second n-type transistor.

Optionally, in any of the preceding aspects, the method further comprises configuring a system controller to generate a PWM signal to control a PWM switch coupled in series with the power switch, configuring a PWM deglitch circuit to generate a deglitch time signal that removes a leading-edge portion of the load current flowing through the power switch, and based on the deglitch time signal, configuring the system controller to extend a trailing edge of the PWM signal to compensate for removal of the leading-edge portion of the load current, wherein the PWM deglitch circuit and the system controller are configured as the overshoot reduction circuit.

Optionally, in any of the preceding aspects, the method further comprises configuring a system controller to generate a PWM signal to control a PWM switch coupled in series with the power switch, configuring the system controller to detect removal of a leading-edge portion of the load current, and configuring the system controller to extend a trailing edge of the PWM signal to compensate for the removal of the leading-edge portion of the load current, wherein the system controller is configured as the overshoot reduction circuit configured to reduce the overshoot occurring at the leading-edge of the load current flowing through the power switch.

In accordance with yet another embodiment, a system comprises a PWM switch, an integrated circuit and a light emitting diode coupled in series between a power source and ground, and a system controller configured to control the PWM switch, wherein the integrated circuit comprises a reference current generation circuit coupled between a first voltage bus and a second voltage bus, wherein the reference current generation circuit is configured to generate a predetermined reference current, a first reference current path comprising a first switch, wherein the predetermined reference current is configured to be mirrored to generate a first reference current in the first reference current path, a load current path comprising a power switch, and a PWM deglitch circuit configured to control the first switch so as to reduce an overshoot occurring at a leading-edge of a load current flowing through the power switch.

Optionally, in the preceding aspect, the PWM deglitch circuit is configured to generate a deglitch time signal that removes a leading-edge portion of the load current flowing through the power switch, and based on the deglitch time signal, the system controller is configured to extend a trailing edge of the PWM signal to compensate for removal of the leading-edge portion of the load current.

Optionally, in any of the preceding aspects, the reference current generation circuit comprises a first p-type transistor and a resistor connected in series between the first voltage bus and the second voltage bus, and a first amplifier having an inverting input configured to receive a bandgap reference, a non-inverting input connected to a common node of the first p-type transistor and the resistor, and an output connected to a gate of the first p-type transistor and a gate of a second p-type transistor, and the first reference current path comprises the second p-type transistor and the first switch connected in series, and wherein the first p-type transistor and the second p-type transistor form a first current mirror through which the predetermined reference current is mirrored to generate the first reference current in the first reference current path.

Optionally, in any of the preceding aspects, the system further comprises a low-dropout regulator having an input configured to receive an input voltage and an output configured to generate a bias voltage on the first voltage bus, an undervoltage lockout circuit configured to receive the bias voltage and generate a control signal applied to a gate of the power switch, wherein a current flowing through the power switch is approximately equal to a current flowing through the light emitting diode, and a bandgap reference circuit configured to receive the bias voltage and generate a bandgap reference.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a light emitting diode system in accordance with various embodiments of the present disclosure;

FIG. 2 illustrates a schematic diagram of a first implementation of the LED driver shown in FIG. 1 in accordance with various embodiments of the present disclosure;

FIG. 3 illustrates a schematic diagram of the PWM deglitch circuit shown in FIG. 2 in accordance with various embodiments of the present disclosure;

FIG. 4 illustrates various signals associated with the PWM deglitch circuit shown in FIG. 3 in accordance with various embodiments of the present disclosure;

FIG. 5 illustrates a schematic diagram of a second implementation of the LED driver shown in FIG. 1 in accordance with various embodiments of the present disclosure;

FIG. 6 illustrates a schematic diagram of a third implementation of the LED driver shown in FIG. 1 in accordance with various embodiments of the present disclosure;

FIG. 7 illustrates various signals associated with the LED driver shown in FIG. 6 in accordance with various embodiments of the present disclosure;

FIG. 8 illustrates a schematic diagram of a fourth implementation of the LED driver shown in FIG. 1 in accordance with various embodiments of the present disclosure;

FIG. 9 illustrates a flow chart of a method for controlling the LED driver shown in FIG. 1 in accordance with various embodiments of the present disclosure;

FIG. 10 illustrates a block diagram of a light emitting diode system having split input voltage rails in accordance with various embodiments of the present disclosure;

FIG. 11 illustrates a schematic diagram of the integrated circuit shown in FIG. 10 in accordance with various embodiments of the present disclosure;

FIG. 12 illustrates various signals associated with the integrated circuit shown in FIG. 11 in accordance with various embodiments of the present disclosure;

FIG. 13 illustrates a block diagram of a first alternative implementation of the light emitting diode system shown in FIG. 1 in accordance with various embodiments of the present disclosure;

FIG. 14 illustrates a schematic diagram of the integrated circuit shown in FIG. 13 in accordance with various embodiments of the present disclosure;

FIG. 15 illustrates various signals associated with the integrated circuit shown in FIG. 14 in accordance with various embodiments of the present disclosure;

FIG. 16 illustrates a block diagram of a second alternative implementation of the light emitting diode system shown in FIG. 1 in accordance with various embodiments of the present disclosure;

FIG. 17 illustrates various signals associated with the light emitting diode system shown in FIG. 16 in accordance with various embodiments of the present disclosure; and

FIG. 18 illustrates a flow chart of a method for controlling the light emitting diode systems shown in FIGS. 10, 13 and 16 in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely an LED current overshoot reduction apparatus. The disclosure may also be applied, however, to a variety of LED systems. Hereinafter, various embodiments will be explained in detail with reference to the accompanying drawings.

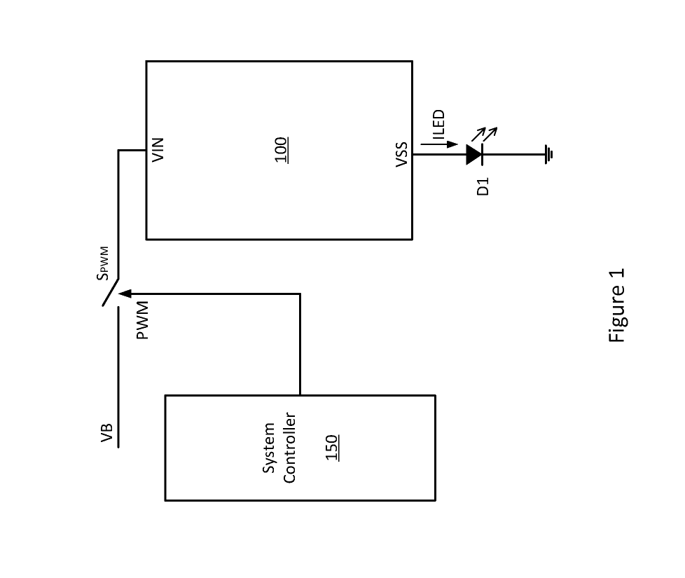

FIG. 1 illustrates a block diagram of a light emitting diode system in accordance with various embodiments of the present disclosure. As shown in FIG. 1, a PWM switch S_{PWM}, an integrated circuit 100 and a light emitting diode D1 are connected in series between a power source VB and ground. A system controller 150 is configured to generate a PWM signal (PWM) for controlling the PWM switch S_{PWM}.

It should be noted that the block diagram shown in FIG. 1 is merely an example. Depending on different applications and design needs, the system configuration may vary accordingly. For example, the light emitting diode D1 may be placed between the PWM switch S_{PWM} and the integrated circuit 100. Furthermore, the PWM switch S_{PWM} may be connected to ground directly. Under this system configuration, the PWM switch S_{PWM} can be implemented as an n-type switch. The n-type switch typically has a lower on-resistance compared to a p-type switch for the same size, leading to lower voltage drops and higher efficiency in the light emitting diode system.

As shown in FIG. 1, a common node of the PWM switch S_{PWM} and the integrated circuit 100 is labeled as VIN. A common node of the integrated circuit 100 and the light emitting diode D1 is labeled as VSS. The current flowing through the light emitting diode D1 is labeled as ILED. Throughout the description, ILED may be alternatively referred to as the LED current.

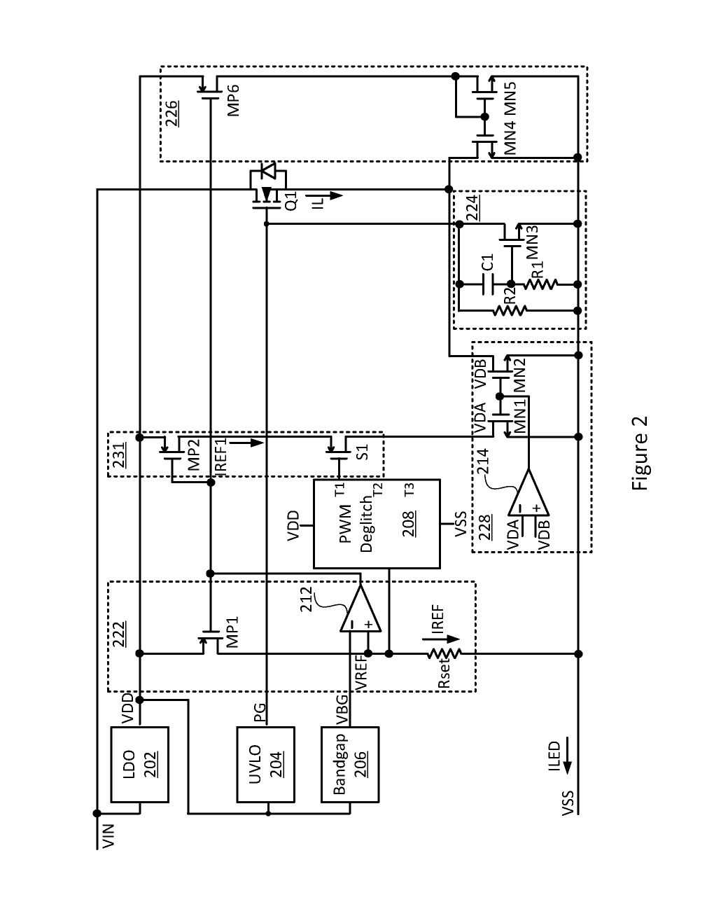

In some embodiments, the system controller 150 controls the PWM switch S_{PWM} according to the power PWM dimming technique. In operation, the brightness of the light emitting diode D1 can be controlled by varying the amount of time the light emitting diode D1 is powered on and off. The brightness of the light emitting diode D1 is determined by the ratio of the on-time to the off-time within each cycle. When the light emitting diode D1 is powered on, the power source VB supplies power to the integrated circuit 100 through the turned-on PWM switch S_{PWM.} When the light emitting diode D1 is powered off, no power is supplied to the integrated circuit 100. Under power PWM dimming, the light emitting diode D1, along with the integrated circuit 100, is rapidly switched on and off at a high frequency. To ensure accurate and linear dimming, the delay time (e.g., soft start) from the PWM signal to the LED current response must be minimized. In a high frequency power PWM dimming process, soft start cannot be employed to lessen the fast PWM transition. The high frequency power PWM dimming process often leads to LED current overshoot. The present disclosure introduces four different implementations to reduce the LED current overshoot. These four different implementations to mitigate this LED current overshoot, which will be described in detail with respect to FIGS. 2, 5, 6 and 8.

In some embodiments, the system controller 150 is implemented as a microcontroller. In alternative embodiments, the system controller 150 may be implemented as any suitable processors such as digital signal processing (DSP) controllers, field-programmable gate array (FPGA) processors and the like.

The PWM switch S_{PWM} shown in FIG. 1 may be implemented as n-type metal oxide semiconductor (NMOS) transistors. Alternatively, the switches may be implemented as other suitable controllable devices such as metal oxide semiconductor field effect transistor (MOSFET) devices, bipolar junction transistor (BJT) devices, super junction transistor (SJT) devices, insulated gate bipolar transistor (IGBT) devices, gallium nitride (GaN) based power devices, any combinations thereof and the like.

The integrated circuit 100 functions as an LED driver. Throughout the description, the integrated circuit 100 may be alternatively referred to as an LED driver 100. In some embodiments, the LED driver 100 comprises a bias power supply, an undervoltage protection circuit, a reference circuit, a reference current generation circuit, a PWM deglitch circuit, a plurality of reference current paths, a precisely controlled current mirror, a power switch, a gate protection circuit and a startup circuit.

In some embodiments, the bias power supply is implemented as a low-dropout regulator. An input of the low-dropout regulator is configured to receive the voltage on VIN, and generate a bias voltage. The undervoltage protection circuit is implemented as an undervoltage lockout circuit. The undervoltage lockout circuit is configured to receive the bias voltage. Once the bias voltage is greater than a predetermined threshold, the undervoltage lockout circuit is configured to generate a control signal applied to the gate of the power switch in the LED driver 100. A current flowing through the power switch is approximately equal to a current flowing through the light emitting diode D1. The reference circuit is implemented as a bandgap reference circuit. The bandgap reference circuit is configured to receive the bias voltage and generate a bandgap reference.

The reference current generation circuit is coupled between the bias voltage and VSS. The reference current generation circuit is configured to generate a predetermined reference current.

In a first implementation of the LED driver 100, the LED driver 100 comprises a first reference current path. The first reference current path comprises a first switch. The predetermined reference current is mirrored to generate a first reference current in the first reference current path. Furthermore, the first reference current is mirrored to generate a load current flowing through the power switch in the LED driver 100. The PWM deglitch circuit is configured to control the first switch so as to reduce an overshoot occurring at a leading-edge of the load current flowing through the power switch. The detailed structure and operating principle of the first implementation of the LED driver 100 will be described below with respect to FIG. 2.

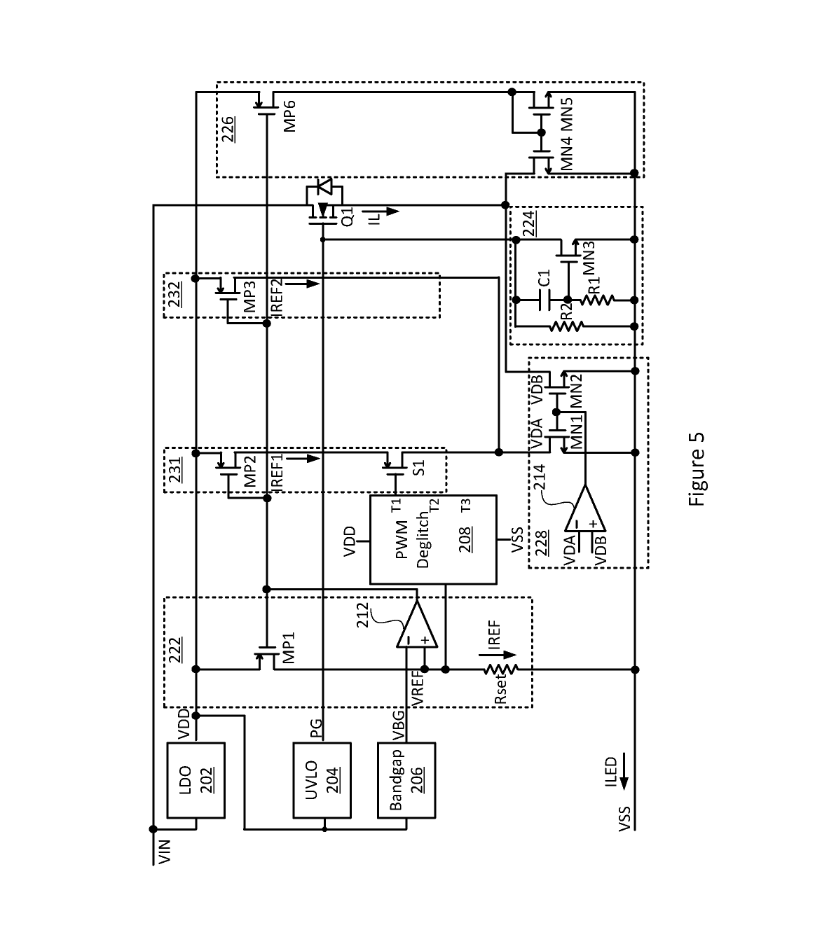

In a second implementation of the LED driver 100, the LED driver 100 comprises a first reference current path and a second reference current path. The second reference current path is connected in parallel with the first reference current path. The first reference current path comprises a first switch. The predetermined reference current is mirrored to generate a first reference current in the first reference current path and a second reference current in the second reference current path. Furthermore, a sum of the first reference current and the second reference current is mirrored to generate a load current flowing through the power switch in the LED driver 100. The PWM deglitch circuit is configured to control the first switch so as to reduce an overshoot occurring at a leading-edge of a load current flowing through the power switch. The detailed structure and operating principle of the second implementation of the LED driver 100 will be described below with respect to FIG. 5.

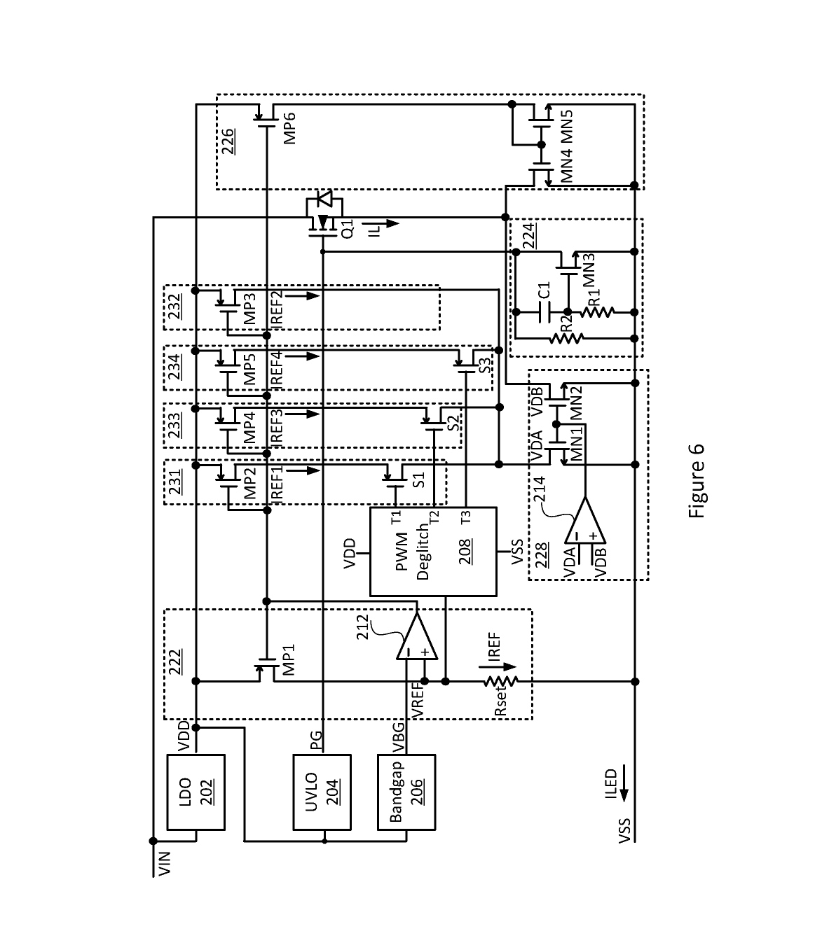

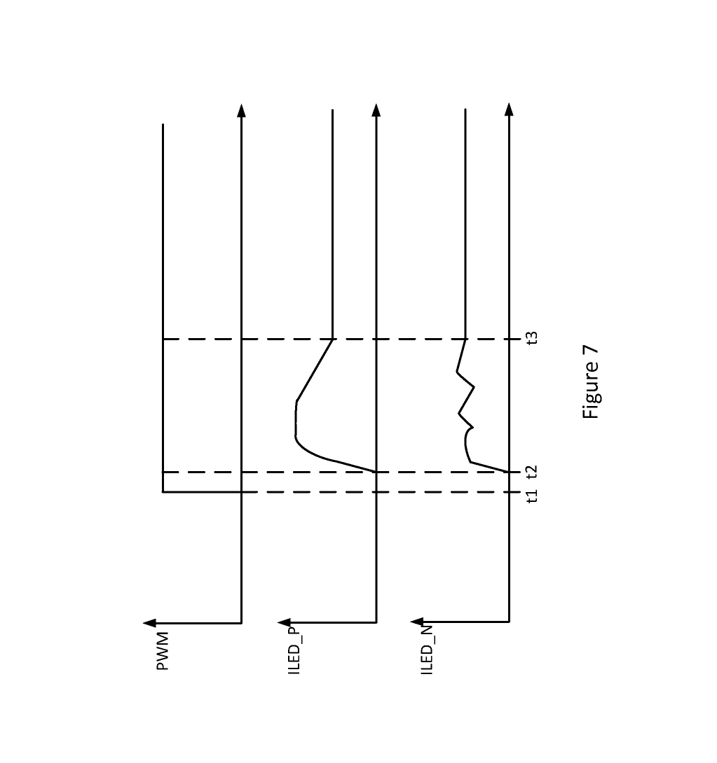

In a third implementation of the LED driver 100, the LED driver 100 comprises a first reference current path, a second reference current path, a third reference current path and a fourth reference current path. The second reference current path is connected in parallel with the first reference current path. The first reference current path comprises a first switch. The third reference current path comprises a second switch. The third reference current path is connected in parallel with the first reference current path. The fourth reference current path comprises a third switch. The fourth reference current path is connected in parallel with the first reference current path. The predetermined reference current is mirrored to generate a first reference current in the first reference current path, a second reference current in the second reference current path, a third reference current in the third reference current path and a fourth reference current in the fourth reference current path. Furthermore, a sum of the first reference current, the second reference current, the third reference current and the fourth reference current is mirrored to generate a load current flowing through the power switch. The PWM deglitch circuit is configured to control the first switch, the second switch and the third switch so as to reduce an overshoot occurring at a leading-edge of the load current flowing through the power switch. The detailed structure and operating principle of the third implementation of the LED driver 100 will be described below with respect to FIGS. 6-7.

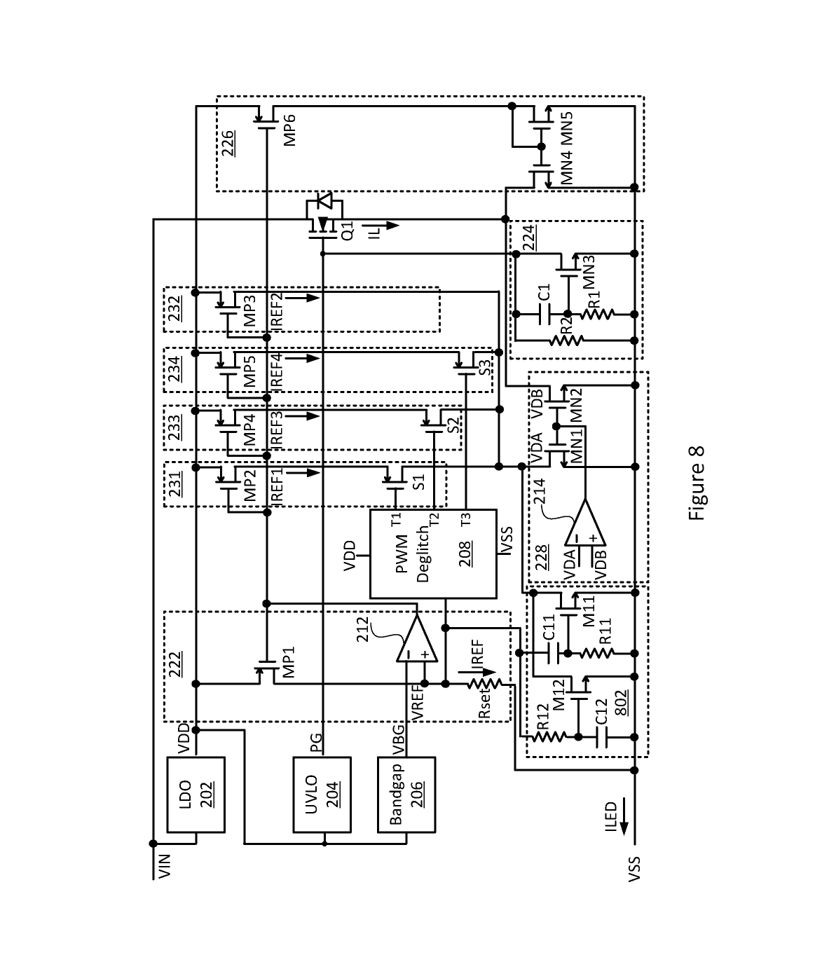

In a fourth implementation of the LED driver 100, the LED driver 100 comprises a first reference current path, a second reference current path, a third reference current path, a fourth reference current path and a reference current subtraction circuit. The second reference current path is connected in parallel with the first reference current path. The first reference current path comprises a first switch. The third reference current path comprises a second switch. The third reference current path is connected in parallel with the first reference current path. The fourth reference current path comprises a third switch. The fourth reference current path is connected in parallel with the first reference current path. The predetermined reference current is mirrored to generate a first reference current in the first reference current path, a second reference current in the second reference current path, a third reference current in the third reference current path and a fourth reference current in the fourth reference current path. Furthermore, a sum of the first reference current, the second reference current, the third reference current and the fourth reference current is mirrored to generate a load current flowing through the power switch. The PWM deglitch circuit is configured to control the first switch, the second switch and the third switch so as to reduce an overshoot occurring at a leading-edge of the load current flowing through the power switch. Moreover, the reference current subtraction circuit is configured to subtract a current component from the sum of the reference currents. The reduced sum of the reference currents can further reduce the overshoot. The detailed structure and operating principle of the fourth implementation of the LED driver 100 will be described below with respect to FIG. 8.

It should be noted that the light emitting diode system shown in FIG. 1 is merely an example. Depending on different applications and design needs, the system configuration may vary accordingly. For example, a current sense resistor may be placed between the light emitting diode and ground. Furthermore, while FIG. 1 illustrates one light emitting diode, the light emitting diode system could accommodate any number of light emitting diodes connected in series and/or parallel.

FIG. 2 illustrates a schematic diagram of a first implementation of the LED driver shown in FIG. 1 in accordance with various embodiments of the present disclosure. The LED driver comprises a low-dropout regulator 202, an undervoltage lockout circuit 204, a bandgap reference circuit 206, a PWM deglitch circuit 208, a reference current generation circuit 222, a first reference current path 231, a power switch Q1, a precisely controlled current mirror 228, a gate protection circuit 224 and a startup circuit 226.

As shown in FIG. 2, an input of the low-dropout regulator 202 is configured to receive an input voltage VIN. The low-dropout regulator 202 is configured to generate a bias voltage VDD. Throughout the description, the voltage bus on which the bias voltage VDD is generated may be alternatively referred to as a first voltage bus. The voltage bus labeled as VSS may be alternatively referred to as a second voltage bus.

The undervoltage lockout circuit 204 is configured to receive the bias voltage VDD. Once the bias voltage VDD is greater than a predetermined threshold, the undervoltage lockout circuit 204 is configured to generate a control signal applied to a gate of the power switch Q1. This control signal keeps the power switch Q1 on. In other words, the control signal functions as a power good (PG) signal.

The bandgap reference circuit 206 is configured to receive the bias voltage VDD and generate a bandgap reference VBG. The bandgap reference VBG is used to set up a reference current IREF as shown in FIG. 2.

The reference current generation circuit 222 comprises a first p-type transistor MP1, a resistor R_{SET} and a first amplifier 212. The first p-type transistor MP1 and the resistor R_{SET} are connected in series between the first voltage bus VDD and the second voltage bus VSS. An inverting input of the first amplifier 212 is configured to receive the bandgap reference VBG. A non-inverting input of the first amplifier 212 is connected to a common node of the first p-type transistor MP1 and the resistor R_{SET}. The voltage on the common node of the first p-type transistor MP1 and the resistor R_{SET} is labeled as VREF as shown in FIG. 2. An output of the first amplifier 212 is connected to a gate of the first p-type transistor MP1.

In operation, the first amplifier 212 forces the voltage on the node VREF to be equal to the bandgap reference VBG. The current flowing through the resistor R_{SET} is equal to the bandgap reference VBG divided by the resistance value of R_{SET}. This current is the reference current IREF of the LED driver. Throughout the description, the voltage on the node VREF may be alternatively referred to as a reference voltage signal.

The first reference current path 231 comprises a second p-type transistor MP2 and a first switch S1 connected in series between the first voltage bus VDD and a voltage node VDA. The gate of the first switch S1 is controlled by the PWM deglitch circuit 208.

In operation, the first p-type transistor MP1 and the second p-type transistor MP2 form a first current mirror. Through the first current mirror, the reference current IREF generated by the reference current generation circuit 222 is mirrored to generate a first reference current IREF1 in the first reference current path 231.

The precisely controlled current mirror 228 comprises a first n-type transistor MN1, a second n-type transistor MN2 and a second amplifier 214. As shown in FIG. 2, the first n-type transistor MN1 and the first reference current path 231 are connected in series between the second voltage bus VSS and the first voltage bus VIN. The second n-type transistor MN2 is connected in series with the power switch Q1. An inverting input of the second amplifier 214 is connected to a drain of the first n-type transistor MN1. The drain of the first n-type transistor MN1 is labeled as VDA as shown in FIG. 2. A non-inverting input of the second amplifier 214 is connected to a drain of the second n-type transistor MN2. The drain of the second n-type transistor MN2 is labeled as VDB as shown in FIG. 2. An output of the second amplifier 214 is connected to the gate of the first n-type transistor MN1 and the gate of the second n-type transistor MN2.

In operation, the second amplifier 214 forces the voltage on the drain of the first n-type transistor MN1 to be equal to the voltage on the drain of the second n-type transistor MN2. Such a voltage relationship helps to achieve a precisely controlled current mirror. Through the precisely controlled current mirror 228, the first reference current IREF1 in the first reference current path 231 is mirrored to generate the load current IL flowing through the power switch Q1. In some embodiments, the ratio of the current flowing through the second n-type transistor MN2 to the current flowing through the first n-type transistor MN1 is in a range from about 1000 to about 10,000. Throughout the description, the precisely controlled current mirror 228 may be alternatively referred to as a second current mirror.

The PWM deglitch circuit 208 is configured to receive the voltage on the voltage node VREF. This voltage is proportional to the reference current IREF. Based on the received voltage on VREF, the PWM deglitch circuit 208 is configured to generate a plurality of control signals for controlling switches in different reference current paths so as to reduce an overshoot occurring at a leading-edge of a load current flowing through the power switch Q1. In the first implementation of the LED driver shown in FIG. 2, the PWM deglitch circuit 208 generates a control signal at a first terminal T1. This control signal is applied to the gate of the first switch S1 to reduce the overshoot of the load current IL.

In operation, PWM switching often introduces transient noise to the functional blocks of the LED driver (e.g., low-dropout regulator 202 and/or bandgap reference circuit 206). During switching or power-up, the transient noise can lead to the overshoot of the load current flowing through the power switch Q1. The PWM deglitch circuit 208 is able to detect the transient noise on the node VREF, and convert the transient noise into a digital signal to control the on and off of the first switch S1. More particularly, when the transient noise occurs at the node VREF, the PWM deglitch circuit 208 converts the transient noise into a logic high signal to turn off the first switch S1. Once the first switch S1 is temporarily turned off, the first reference current IREF1 is reduced, thereby reducing the overshoot of the load current IL flowing through the power switch Q1.

The load current path of the LED driver comprises the power switch Q1. The load current IL flows through the power switch Q1. The LED current ILED includes some bias currents (e.g., IREF). Since the bias currents of the LED driver are quite small, the load current IL is approximately equal to the LED current ILED.

The gate protection circuit 224 is connected between the gate of the power switch Q1 and the second voltage bus VSS. The gate protection circuit 224 comprises a first resistor R1, a second resistor R2, a capacitor C1 and a third n-type transistor MN3. The third n-type transistor MN3 is connected between the gate of the power switch Q1 and the second voltage bus VSS. The first resistor R1 and the capacitor C1 are connected in series between the gate of the power switch Q1 and the second voltage bus VSS. The second resistor R2 is connected between the gate of the power switch Q1 and the second voltage bus VSS.

In operation, the gate protection circuit 224 serves two functions. First, the capacitor C1, the first resistor R1 and the third n-type transistor MN3 form a voltage clamping circuit configured to provide various protections such as electrostatic discharge (ESD) and electrical overstress (EOS) protection. When there is a fast voltage event from the input voltage bus VIN, such as ESD or power switching, a high-voltage transient can travel from the drain terminal of the power switch Q1 to its gate through the parasitic Miller capacitance of the power switch Q1. This fast transient can turn on the third n-type transistor MN3, thereby keeping the gate voltage of Q1 at a safe level. Second, the second resistor R2 provides a passive pulldown for the power switch Q1, helping the undervoltage lockout circuit 204 keep the power switch Q1 off when the LED drive operates in an undervoltage condition.

The startup circuit 226 comprises a third current mirror comprising a fourth n-type transistor MN4 and a fifth n-type transistor MN5. The startup circuit 226 further comprises a sixth p-type transistor MP6. As shown in FIG. 2, the sixth p-type transistor MP6 and the fifth n-type transistor MN5 are connected in series between the first voltage bus VDD and the second voltage bus VSS. The power switch Q1 and the fourth n-type transistor MN4 are connected in series between the input voltage bus VIN and the second voltage bus VSS. The gate of the sixth p-type transistor MP6 is connected to the gate of the first p-type transistor MP1. The reference current IREF is mirrored to generate a current flowing through the sixth p-type transistor MP6.

In operation, the precisely controlled current mirror 228 has multiple stable states. The startup circuit 226 ensures that an initial current flows, prompting the precisely controlled current mirror 228 to enter its correct operating state.

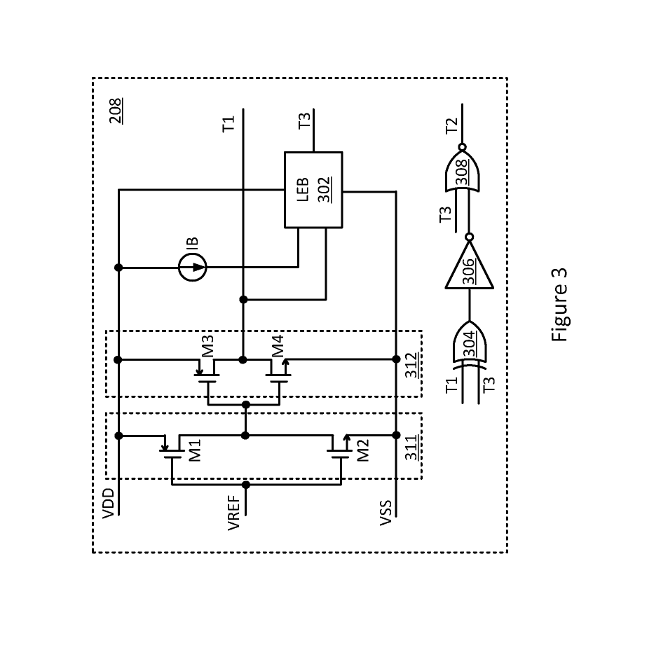

FIG. 3 illustrates a schematic diagram of the PWM deglitch circuit shown in FIG. 2 in accordance with various embodiments of the present disclosure. The PWM deglitch circuit 208 comprises a first inverter 311, a second inverter 312, a current source IB, a leading-edge blanking circuit 302, an XOR gate 304, an inverter 306 and an NOR gate 308. The first inverter 311 is formed by a p-type transistor M1 and an n-type transistor M2 connected in series between VDD and VSS. The second inverter 312 is formed by a p-type transistor M3 and an n-type transistor M4 connected in series between VDD and VSS.

As shown in FIG. 3, the first inverter 311 is configured to receive the reference voltage signal VREF. The reference voltage signal VREF is proportional to the reference current IREF. In some embodiments, the threshold voltage of the first inverter 311 is selected such that the first inverter 311 switches its output from a logic high state to a logic low state when VREF exceeds its target or steady state value. In other words, the steady state value of VREF may be selected as the threshold voltage of the first inverter 311. Once VREF is greater than this threshold voltage, the first inverter generates a logic low signal fed into the second inverter 312.

As shown in FIG. 3, the second inverter 312 has an input connected to the output of the first inverter 311. The output of the second inverter 312 is configured to generate a first control signal applied to a first terminal T1. Referring back to FIG. 2, T1 is connected to the gate of the first switch S1. When an overshoot occurs, the leading-edge portion of VREF exceeds the steady state value of VREF. In response to this, the first inverter 311 generates a logic low signal. The second inverter 312 converts this logic low signal into a logic high signal applied to the gate of the first switch S1. Since the first switch S1 is a p-type transistor, the logic high signal turns off the first switch S1. Referring back to FIG. 2, once the first switch S1 is turned off, the current flowing through the power switch Q1 is reduced. The reduced load current helps reduce the overshoot of the LED current ILED.

The leading-edge blanking circuit 302 may comprise a timer, an inverter and an AND gate. The current source IB provides a bias current for the timer. The timer is configured to generate a blanking pulse in response to the leading-edge of VREF. The blanking pulse is fed into the inverter. A first input of the AND gate is configured to receive the first control signal (T1). A second input of the AND gate is configured to receive the output signal of the inverter. In this way, the AND gate only allows the first control signal to pass through and reach the third terminal T3 after the blanking period is over. The signal generated at the third terminal T3 is a third control signal. The third control signal will be described in detail below with respect to FIG. 6.

The XOR gate 304, the inverter 306 and the NOR gate 308 are connected in cascade as shown in FIG. 3. A first input of the XOR gate 304 is configured to receive the first control signal (T1). A second input of the XOR gate 304 is configured to receive the third control signal (T3). An input of the inverter 306 is connected to an output of the XOR gate 304. A first input of the NOR gate 308 is configured to receive the third control signal (T3). A second input of the NOR gate 308 is connected to an output of the inverter 306. An output of the NOR gate 308 is configured to generate a control signal at the second terminal T2. The signal generated at the second terminal T2 is a second control signal. The second control signal will be described in detail below with respect to FIG. 6.

In response to an overshoot of VREF, the PWM deglitch circuit 208 is able to generate three control signals. The duration of the logic high state of the first control signal (T1) is approximately equal to the duration of the overshoot of VREF. The first control signal is simultaneously divided into two portions. The leading portion is the second control signal (T2). The trailing portion is the third control signal (T3). These three control signals function as three control variables to turn off corresponding reference current paths, thereby reducing the overshoot of the load current IL flowing through the power switch Q1.

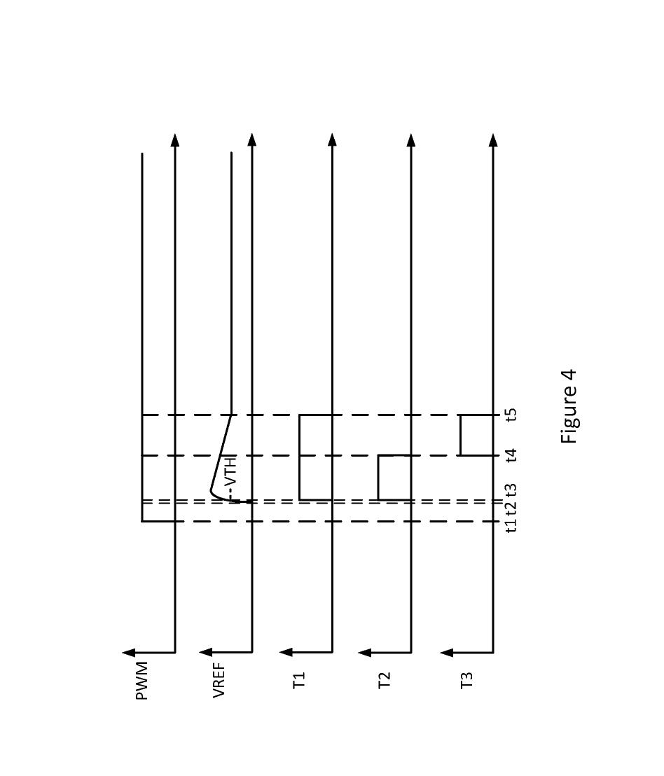

FIG. 4 illustrates various signals associated with the PWM deglitch circuit shown in FIG. 3 in accordance with various embodiments of the present disclosure. The horizontal axis represents intervals of time. There are five rows. The first row represents the PWM signal shown in FIG. 1. The second row represents the reference voltage signal VREF. The third row represents the first control signal T1. The fourth row represents the second control signal T2. The fifth row represents the third control signal T3.

At t1, the PWM signal changes from a logic low state to a logic high state. In response to this change, the PWM switch is turned on and power is supplied to the LED driver. After a suitable circuit delay, the reference voltage signal VREF starts to establish from t2. As shown in FIG. 4, an overshoot of VREF occurs. At t3, the overshoot exceeds the threshold voltage VTH of the first inverter 311. The first inverter 311 and the second inverter 312 collectively function as a buffer. From t3 to t5, the overshoot is greater than threshold voltage VTH. As a result, the first control signal (T1) is of a logic high state from t3 to t5. Referring back to FIG. 3, through the XOR gate 304, the inverter 306 and the NOR gate 308, the leading portion (from t3 to t4) of the first control signal (T1) is generated as the second control signal (T2). Through the leading-edge blanking circuit 302, the trailing portion (from t4 to t5) of the first control signal (T1) is generated as the third control signal (T3).

FIG. 5 illustrates a schematic diagram of a second implementation of the LED driver shown in FIG. 1 in accordance with various embodiments of the present disclosure. The second implementation of the LED driver is similar to the first implementation of the LED driver shown in FIG. 2 except that a second reference current path 232 is added. As shown in FIG. 5, the second reference current path 232 is connected in parallel with the first reference current path 231. The second reference current path 232 comprises a third p-type transistor MP3. The reference current IREF is mirrored to generate a second reference current IREF2 in the second reference current path 232. A sum of the first reference current IREF1 and the second reference current IREF2 is mirrored to generate the load current IL flowing through the power switch Q1.

The second reference current path 232 does not comprise a switch controlled by the PWM deglitch circuit 208. In operation, the second reference current IREF2 in the second reference current path 232 is unchanged. The PWM deglitch circuit 208 can only partially cancel the overshoot through turning off the first switch S1 in the first reference current path 231.

FIG. 6 illustrates a schematic diagram of a third implementation of the LED driver shown in FIG. 1 in accordance with various embodiments of the present disclosure. The third implementation of the LED driver is similar to the second implementation of the LED driver shown in FIG. 5 except that a third reference current path 233 and a fourth reference current path 234 are added to further improve the performance of the LED driver.

As shown in FIG. 6, the third reference current path 233 is connected in parallel with the first reference current path 231. The third reference current path 233 comprises a fourth p-type transistor MP4 and a second switch S2 connected in series. The second switch S2 is implemented as a p-type transistor. The second switch S2 is controlled by the PWM deglitch circuit 208.

The fourth reference current path 234 is connected in parallel with the first reference current path 231. The fourth reference current path 234 comprises a fifth p-type transistor MP5 and a third switch S3 connected in series. The third switch S3 is implemented as a p-type transistor. The third switch S3 is controlled by the PWM deglitch circuit 208.

In operation, the reference current IREF is mirrored to generate a first reference current IREF1 in the first reference current path 231. The reference current IREF is mirrored to generate a second reference current IREF2 in the second reference current path 232. The reference current IREF is mirrored to generate a third reference current IREF3 in the third reference current path 233. The reference current IREF is mirrored to generate a fourth reference current IREF4 in the fourth reference current path 234. A sum of the first reference current IREF1, the second reference current IREF2, the third reference current IREF3 and the fourth reference current IREF4 is mirrored to generate the load current IL flowing through the power switch Q1. In response to the overshoot of the reference voltage signal VREF, the PWM deglitch circuit 208 is configured to turn off the control switches S1, S2 and S3 so as to reduce the sum of the reference currents, thereby reducing the overshoot of the load current IL flowing through the power switch Q1.

FIG. 7 illustrates various signals associated with the LED driver shown in FIG. 6 in accordance with various embodiments of the present disclosure. The horizontal axis represents intervals of time. There are three rows. The first row represents the PWM signal. The second row represents the LED current (LED_P) when a conventional LED driver is employed to drive a light emitting diode. The third row represents the LED current (LED_N) when the LED driver shown in FIG. 6 is employed to drive the light emitting diode.

At t1, the PWM signal changes from a logic low state to a logic high state. In response to this change, the PWM switch is turned on and power is supplied to the LED driver. After a suitable circuit delay, the LED current starts to establish at t2. When a conventional LED driver is employed to drive a light emitting diode, there is an overshoot from t2 to t3. As shown in FIG. 7, the LED current rapidly increases to a peak, remains constant for a period, and then begins to linearly decrease to its steady-state value. In contrast, when the LED driver shown in FIG. 6 is employed to drive the light emitting diode, the LED current increases in a linear manner to an intermediate value, and then curves downward to a first valley. From the first valley, the LED current increases to a first peak, and then linearly decreases to a second valley. From the second valley, the LED current increases to a second peak, and then begins to linearly decrease to its steady-state value. The peak (e.g., the second peak) in the third row is much lower than the peak in the second row.

FIG. 8 illustrates a schematic diagram of a fourth implementation of the LED driver shown in FIG. 1 in accordance with various embodiments of the present disclosure. The fourth implementation of the LED driver is similar to the third implementation of the LED driver shown in FIG. 6 except that a reference current subtraction circuit 802 is added to further improve the performance of the LED driver.

The reference current subtraction circuit 802 comprises a first current subtraction transistor M11, a rise detection capacitor C11, a rise detection resistor R11, a second current subtraction transistor M12, a fall detection resistor R12 and a fall detection capacitor C12.

As shown in FIG. 8, the first current subtraction transistor M11 is connected between the drain of the first n-type transistor MN1 and the second voltage bus VSS. The rise detection capacitor C11 and the rise detection resistor R11 are connected in series between the common node of the first p-type transistor MP1 and the resistor R_{SET}, and the second voltage bus VSS. A common node of the rise detection capacitor C11 and the rise detection resistor R11 is connected to the gate of the first current subtraction transistor M11.

The second current subtraction transistor M12 is connected between the drain of the first n-type transistor MN1 and the second voltage bus VSS. The fall detection resistor R12 and the fall detection capacitor C12 are connected in series between the common node of the first p-type transistor MP1 and the resistor R_{SET}, and the second voltage bus VSS. The common node of the fall detection resistor R12 and the fall detection capacitor C12 is connected to the gate of the second current subtraction transistor M12.

In operation, the reference current subtraction circuit 802 is configured to subtract a current component from the sum of the reference currents, thereby reducing the overshoot occurring at the leading-edge of the load current IL. The rise detection capacitor C11 and the rise detection resistor R11 set the delay timing for the rising section of the overshoot signal, while the fall detection resistor R12 and the fall detection capacitor C12 set the delay timing for the falling section of the overshoot signal. To further improve the subtraction amplitude, simply adjust the channel widths of the first current subtraction transistor M11 and the second current subtraction transistor M12.

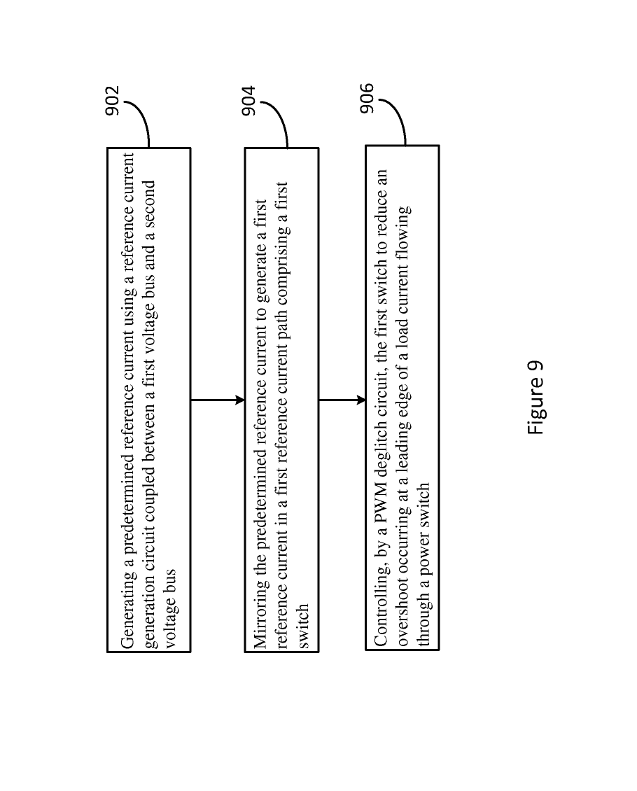

FIG. 9 illustrates a flow chart of a method for controlling the LED driver shown in FIG. 1 in accordance with various embodiments of the present disclosure. This flowchart shown in FIG. 9 is merely an example, which should not unduly limit the scope of the claims. One of ordinary skill in the art would recognize many variations, alternatives, and modifications. For example, various steps illustrated in FIG. 9 may be added, removed, replaced, rearranged and repeated.

At step 902, a predetermined reference current is generated using a reference current generation circuit coupled between a first voltage bus and a second voltage bus.

At step 904, the predetermined reference current is mirrored to generate a first reference current in a first reference current path comprising a first switch.

At step 906, the first switch is controlled by a PWM deglitch circuit to reduce an overshoot occurring at a leading-edge of a load current flowing through a power switch.

The method further comprises mirroring the predetermined reference current to generate a second reference current in a second reference current path, and mirroring a sum of the first reference current and the second reference current to generate the load current flowing through the power switch, wherein the second reference current path is connected in parallel with the first reference current path.

The method further comprises mirroring the predetermined reference current to generate a second reference current in a second reference current path, mirroring the predetermined reference current to generate a third reference current in a third reference current path, mirroring the predetermined reference current to generate a fourth reference current in a fourth reference current path, and mirroring a sum of the first reference current, the second reference current, the third reference current and the fourth reference current to generate the load current flowing through the power switch, and wherein the second reference current path is connected in parallel with the first reference current path, the third reference current path is connected in parallel with the first reference current path, and wherein the third reference current path comprises a second switch controlled by the PWM deglitch circuit, and the fourth reference current path is connected in parallel with the first reference current path, wherein the fourth reference current path comprises a third switch controlled by the PWM deglitch circuit.

The reference current generation circuit comprises a first p-type transistor and a resistor connected in series between the first voltage bus and the second voltage bus, and a first amplifier having an inverting input configured to receive a bandgap reference, a non-inverting input connected to a common node of the first p-type transistor and the resistor and an output connected to a gate of the first p-type transistor and a gate of a second p-type transistor, the first reference current path comprises the second p-type transistor and the first switch connected in series, and wherein the first p-type transistor and the second p-type transistor form a first current mirror through which the predetermined reference current is mirrored to generate the first reference current in the first reference current path, and a second current mirror comprises a first n-type transistor connected in series with the first reference current path, a second n-type transistor connected in series with the power switch, wherein the first n-type transistor and the second n-type transistor form a second current mirror through which the sum of the first reference current, the second reference current, the third reference current and the fourth reference current is mirrored to generate the load current flowing through the power switch, and a second amplifier having an inverting input connected to a drain of the first n-type transistor, a non-inverting input connected to a drain of the second n-type transistor and an output connected to a gate of the first n-type transistor and a gate of the second n-type transistor.

The PWM deglitch circuit comprises a first inverter configured to receive a reference voltage signal proportional to the predetermined reference current, a second inverter having an input connected to an output of the first inverter and an output configured to generate a first control signal applied to a gate of the first switch, a leading-edge blanking circuit having an input configured to receive the first control signal and an output configured to generate a third control signal applied to a gate of the third switch, and an XOR gate, an inverter and an NOR gate connected in cascade, wherein a first input of the XOR gate is configured to receive the first control signal, a second input of the XOR gate is configured to receive the third control signal, an input of the inverter is connected to an output of the XOR gate, a first input of the NOR gate is configured to receive the third control signal, a second input of the NOR gate is connected to an output of the inverter, and an output of the NOR gate is configured to generate a second control signal applied to a gate of the second switch.

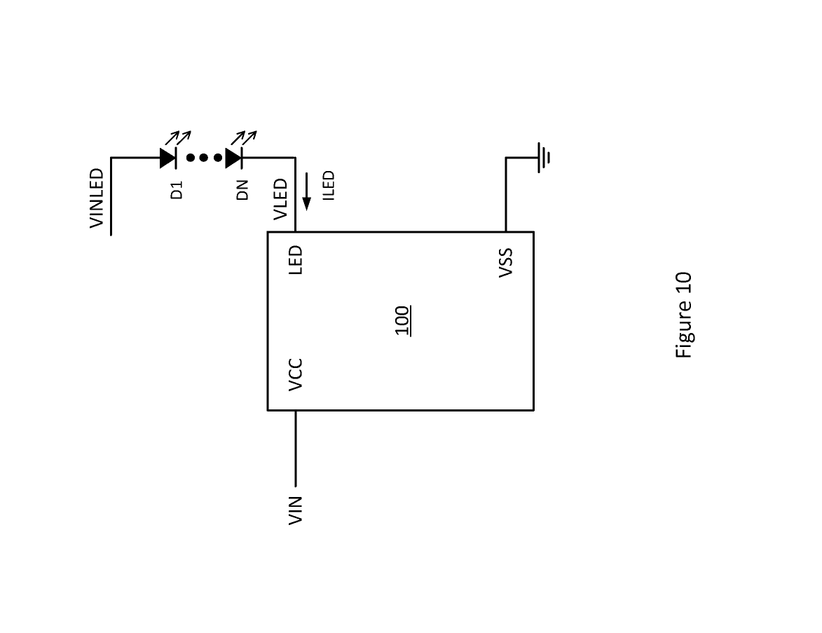

FIG. 10 illustrates a block diagram of a light emitting diode system having split input voltage rails in accordance with various embodiments of the present disclosure. Unlike the single-rail configuration shown in FIG. 1, the LED system of FIG. 10 employs two separate power rails, namely a first input voltage rail VIN and a second LED voltage rail VLED. A bias input VCC of the integrated circuit 100 is coupled to the VIN rail.

An LED string is coupled between a power source VINLED and the voltage rail VLED. The LED string comprises one or more light emitting diodes (e.g., D1 through DN). The current flowing through the LED string is denoted as ILED as shown in FIG. 10. Throughout the description, the LED current ILED may be alternatively referred to as a load current.

In this split-rail architecture, VIN supplies power to the internal circuitry of the integrated circuit 100. The internal circuitry includes the bias generation circuit, the reference circuit, the control circuitry and the like. VINLED supplies power for driving the LED string through the voltage rail VLED. In the embodiment shown in FIG. 10, VINLED is not directly connected to the integrated circuit 100. Instead, the voltage rail VLED, which is derived from VINLED, is directly connected to the integrated circuit 100. Accordingly, although VINLED provides the external power source for the LED string, VLED is used as the operative supply node coupled to the integrated circuit 100. During operation, VLED generally tracks VINLED such that when VINLED decreases or increases, VLED correspondingly decreases or increases.

In operation, VINLED is powered up substantially simultaneously with VIN. If VIN powers up first while VINLED remains at a low voltage level, the control circuit of the integrated circuit 100 may attempt to regulate the LED current before sufficient headroom is available across the LED string. As a result, an undesired overshoot of the LED current ILED may occur during startup.

To reduce the overshoot occurring at a leading-edge of the LED current ILED, an additional undervoltage lockout (UVLO) circuit is implemented to monitor the voltage associated with VINLED. In some embodiments, instead of directly sensing VINLED, the UVLO circuit monitors a voltage node associated with the power switch (e.g., a source node of the power transistor), thereby allowing the UVLO circuit to operate within a lower voltage domain for improved cost efficiency and reliability.

In operation, when the monitored voltage is below a predetermined threshold, the UVLO circuit prevents the load current from increasing by pulling down the control signal of a current mirror through which the load current flows. In this manner, the overshoot portion of the load current is effectively suppressed.

In operation, once the monitored voltage rises above the predetermined threshold, the UVLO circuit releases the lockout condition, thereby allowing the load current (ILED) to increase in a controlled manner. By blocking current conduction when VINLED is insufficient and permitting normal operation after VINLED reaches a level sufficient for proper operation of the current control loop, the overshoot of the LED current is effectively reduced or eliminated.

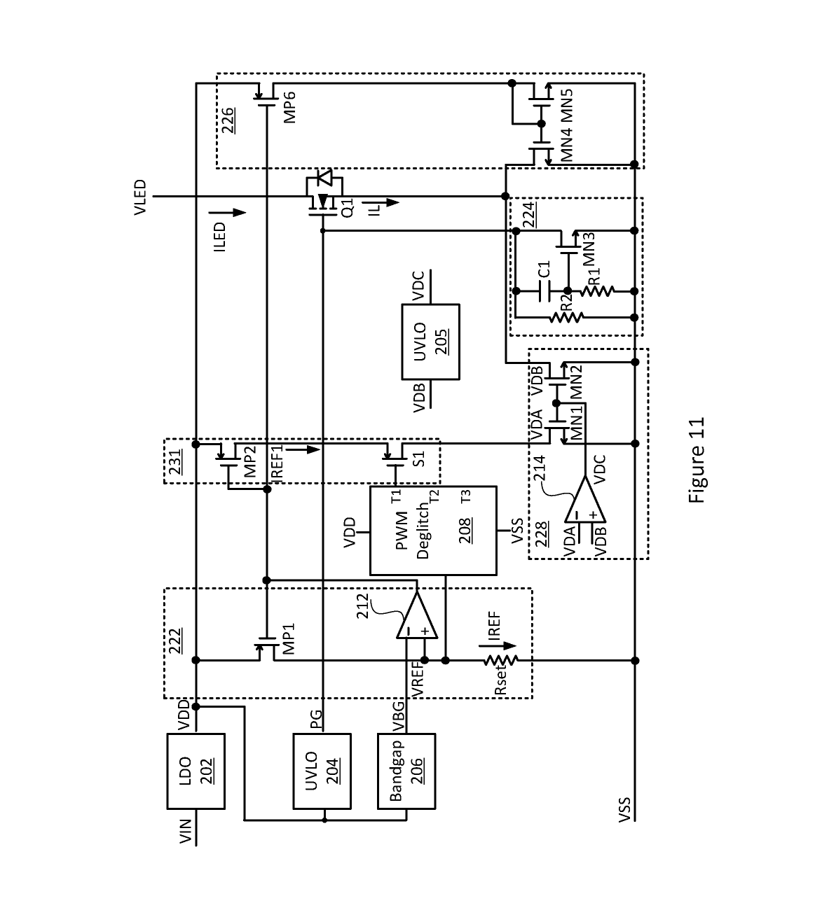

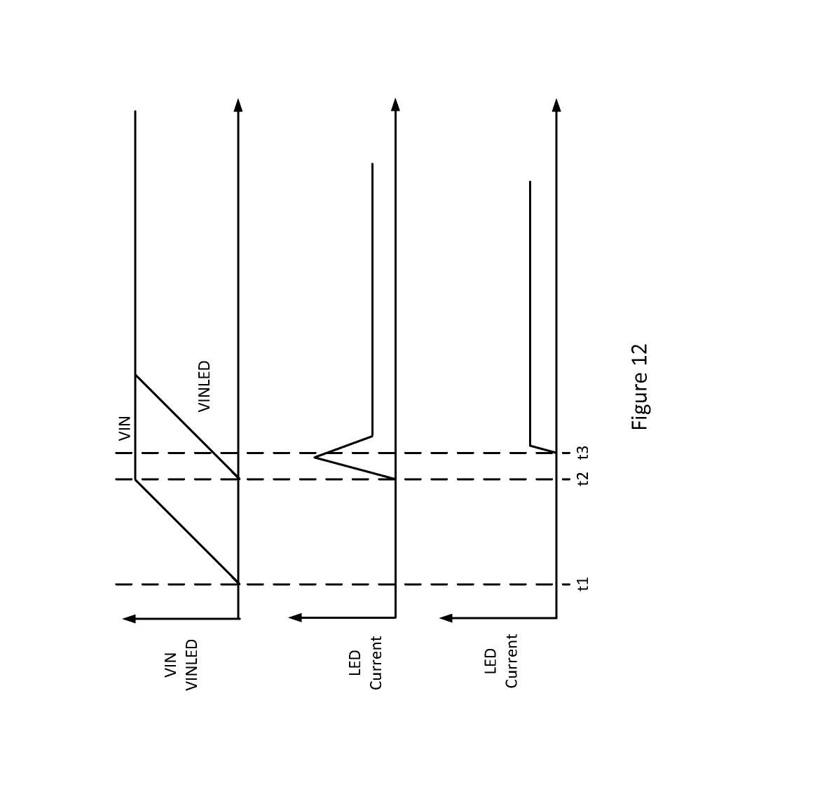

This split-rail architecture shown in FIG. 10 provides a simple and cost-efficient solution for suppressing LED current overshoot during startup conditions. The detailed operating principle will be described below with respect to FIGS. 11-12.

FIG. 11 illustrates a schematic diagram of the integrated circuit shown in FIG. 10 in accordance with various embodiments of the present disclosure. The integrated circuit of FIG. 11 is similar to the integrated circuit shown in FIG. 2 except that the power switch Q1 is connected to the voltage rail VLED, and an additional UVLO circuit 205 is incorporated to further reduce LED current overshoot during startup.

As shown in FIG. 11, the integrated circuit 100 includes the low-dropout regulator 202, the first UVLO circuit 204 configured to monitor the bias voltage, the bandgap reference circuit 206, the reference current generation circuit 222, the PWM deglitch circuit 208, the precisely controlled current mirror 228, and the power switch Q1. The configuration of the integrated circuit 100 shown in FIG. 11 is similar to that described with respect to FIG. 2 except that the drain of the power switch Q1 is coupled to the voltage rail VLED rather than directly to VIN.

In addition to the first UVLO circuit 204, the second UVLO circuit 205 is provided. The second UVLO circuit 205 is configured to receive a voltage signal indicative of the voltage of VINLED. In the illustrated embodiment, the second UVLO circuit 205 monitors the voltage at the node VDB, which corresponds to the drain of the second n-type transistor MN2. VDB is indicative of the voltage on VLED, which in turn is derived from and tracks VINLED.

During startup, if VINLED is low, the voltage at node VDB is correspondingly low. When the voltage at VDB is below a predetermined threshold, the second UVLO circuit 205 forces the control node VDC to a logic low state. Because VDC is connected to the output of the second amplifier 214 and controls the gates of n-type transistors MN1 and MN2 in the precisely controlled current mirror 228, pulling VDC low effectively prevents establishment of the load current IL through the power switch Q1. As a result, no substantial LED current flows when VINLED is not sufficient. In some embodiments, the second UVLO circuit 205 comprises an open-drain output stage configured to actively pull the control node VDC low and to otherwise present a high impedance state.

During startup, once VINLED increases to a level high enough to support proper current regulation, the voltage at VDB rises above the predetermined threshold. In response to this change, the second UVLO circuit 205 releases the logic low state on VDC, allowing the second amplifier 214 to operate normally. The precisely controlled current mirror 228 then mirrors the reference current IREF to establish the load current IL.

In some embodiments, the output signal PG of the first UVLO circuit 204 is about 3.3 V. The gate-to-source voltage of Q1 is about 1 V. At normal operating conditions, the voltage at VDB is equal to PG minus the gate-to-source voltage of Q1. It is about 2.3 V. The predetermined threshold of the second UVLO circuit 205 is about 1 V. During startup, when VLED is less than about 1 V, VDB cannot reach 2.3 V while PG is about 3.3 V. The second UVLO circuit 205 generates a logic low signal to disable the precisely controlled current mirror 228, thereby preventing establishment of the load current IL through the power switch Q1. Conversely, after VLED exceeds about 1 V, the voltage at VDB rises above about 1 V. The second UVLO circuit 205 ceases pulling the output low and places the output in a high impedance state, thereby releasing the precisely controlled current mirror 228 to operate normally and allowing the load current to be established accordingly.

One advantageous feature of the system configuration shown in FIG. 11 is that, by preventing current conduction until VLED reaches a sufficient level, the second UVLO circuit 205 effectively blocks the premature establishment of the load current that would otherwise cause a startup overshoot. Consequently, the overshoot of the LED current is significantly reduced or eliminated.

FIG. 12 illustrates various signals associated with the integrated circuit shown in FIG. 11 in accordance with various embodiments of the present disclosure. The horizontal axis represents time. There are four rows. The first row illustrates the input voltage VIN and VINLED. The second row illustrates the LED current when the control scheme employing the second UVLO 205 is not used. The third row illustrates the LED current when the control scheme of FIG. 11 is employed.

At time t1, the input voltage VIN begins to ramp up. Because the internal circuitry of the integrated circuit is powered from VIN through the low-dropout regulator, the internal bias and control circuits begin to establish after t1.

At time t2, VINLED begins to ramp up. In a split-rail architecture, it is possible for VIN to rise earlier than VINLED. If the LED current control loop attempts to regulate the load current as soon as VINLED starts to rise, but before VINLED reaches a sufficient voltage level, the control loop may operate with insufficient headroom across the LED string.

As shown in the second row, when the second UVLO circuit 205 is not employed, the LED current begins to ramp up at approximately t2, even though VINLED is still at a relatively low voltage level. Because VINLED is not sufficient to support proper current regulation, the current control loop may overdrive the power switch Q1 and MN2, resulting in a significant overshoot of the LED current.

In contrast, when the second UVLO circuit 205 shown in FIG. 11 is used, the voltage at node VDB is monitored. At time t3, the voltage at the node VDB rises above the threshold of the second UVLO circuit 205. The second UVLO circuit 205 releases the control node VDC, allowing the load current to establish. Consequently, the LED current in the third row begins to rise at approximately t3 rather than t2.

Because VINLED has reached a sufficiently high level at t3, the current regulation loop operates within its normal operating range, and the LED current increases in a controlled manner without producing a large overshoot. As illustrated in the third row, the peak LED current is substantially reduced compared to the second row.

Accordingly, by delaying the establishment of the load current until the voltage at the node VDB exceeds the threshold of the second UVLO 205, the startup overshoot associated with split-rail operation is effectively avoided.

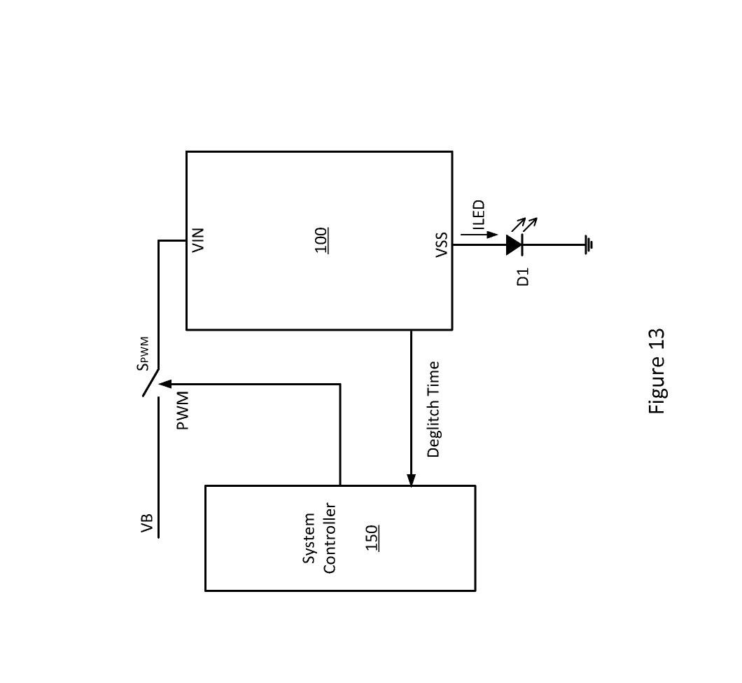

FIG. 13 illustrates a block diagram of a first alternative implementation of the light emitting diode system shown in FIG. 1 in accordance with various embodiments of the present disclosure. The system configuration of FIG. 13 is similar to that of FIG. 1 except that a deglitch time signal is provided from the integrated circuit 100 to the system controller 150.

As shown in FIG. 13, the PWM switch S_{PWM}, the integrated circuit 100, and the light emitting diode D1 are coupled in series between the power source VB and ground. The system controller 150 is configured to generate a PWM signal to control the PWM switch S_{PWM}, thereby adjusting the average LED current ILED according to a power PWM dimming technique.

In this embodiment, the PWM deglitch circuit 208 within the integrated circuit 100 is configured to generate a deglitch time signal. The deglitch time signal represents a duration during which a leading-edge portion of the load current flowing through the power switch is chopped in order to reduce current overshoot. In other words, the deglitch time signal corresponds to an amount of current that has been temporarily removed from the leading portion of the load current waveform.

The deglitch time signal is fed into the system controller 150. Based on the received deglitch time signal, the system controller 150 adjusts the PWM signal by extending a trailing edge of the PWM pulse. More particularly, the system controller 150 increases the on-time of the PWM signal by an amount corresponding to the deglitch time. By extending the trailing edge, the system compensates for the current portion removed at the leading edge, thereby restoring the intended average LED current.

Through this coordinated interaction between the PWM deglitch circuit 208 and the system controller 150, overshoot at the leading edge of the load current can be suppressed while maintaining accurate PWM dimming performance. As a result, dimming linearity and brightness accuracy are improved without sacrificing overshoot reduction capability.

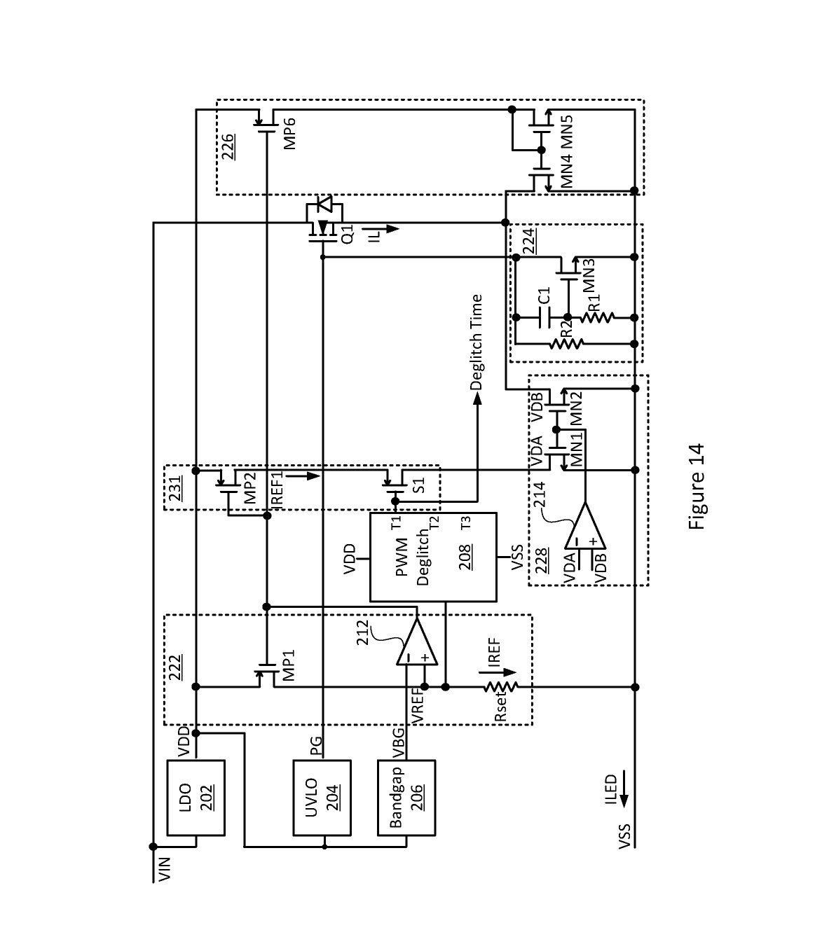

FIG. 14 illustrates a schematic diagram of the integrated circuit shown in FIG. 13 in accordance with various embodiments of the present disclosure. The circuit of FIG. 14 is similar to the circuit shown in FIG. 2 except that the PWM deglitch circuit 208 is configured to generate a deglitch time signal fed into the system controller 150.

As shown in FIG. 14, the integrated circuit 100 includes the low-dropout regulator 202, the undervoltage lockout circuit 204, the bandgap reference circuit 206, the reference current generation circuit 222, the precisely controlled current mirror 228, the power switch Q1, and the PWM deglitch circuit 208. The configuration of FIG. 14 is similar to that described with respect to FIG. 2. The PWM deglitch circuit 208 continues to control the first switch S1 to suppress overshoot occurring at the leading edge of the load current IL.

In this embodiment, the PWM deglitch circuit 208 additionally generates a deglitch time signal that corresponds to a duration during which the leading-edge portion of the load current has been reduced or removed. The deglitch time signal may be derived from internal control signals (e.g., T1) that represent the interval during which the reference current path is disabled to mitigate overshoot.

The deglitch time signal is provided to the system controller 150 as illustrated in FIG. 13. Upon receiving the deglitch time signal, the system controller 150 is configured to adjust the PWM control signal applied to the PWM switch S_{PWM}. In particular, the system controller 150 extends a trailing edge of the PWM signal by a time period corresponding to the deglitch time, thereby compensating for the portion of load current removed during the leading-edge suppression interval. Accordingly, the embodiment of FIG. 14 enables coordinated internal overshoot reduction and external PWM timing compensation, thereby achieving both reduced LED current overshoot and improved dimming accuracy.

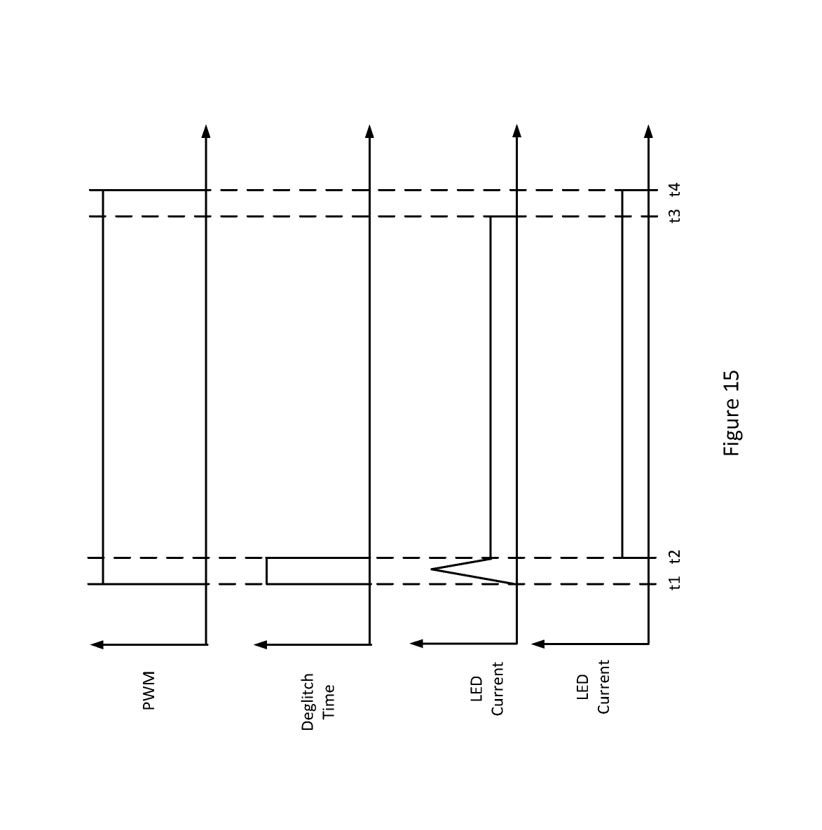

FIG. 15 illustrates various signals associated with the integrated circuit shown in FIG. 14 in accordance with various embodiments of the present disclosure. The horizontal axis represents time. There are four rows. The first row illustrates the PWM signal generated by the system controller 150. The second row illustrates the deglitch time signal generated by the PWM deglitch circuit 208. The third row illustrates the LED current when the control scheme shown in FIGS. 13-14 is not employed. The fourth row illustrates the LED current when the control scheme of FIGS. 13-14 is employed.

At time t1, the PWM signal transitions from a logic low state to a logic high state, thereby turning on the PWM switch and supplying power to the integrated circuit 100. In response to this transition, the PWM deglitch circuit 208 generates a deglitch time signal extending from t1 to t2. During this interval, the leading-edge portion of the load current is intentionally suppressed in order to reduce overshoot. As a result, the LED current shown in the fourth row is held substantially at zero from t1 to t2.

After time t2, the deglitch time signal terminates, and the load current is allowed to establish. The LED current then increases in a controlled manner without producing the large overshoot shown in the third row. However, because the current is suppressed from t1 to t2, a portion of the intended LED current corresponding to this interval is effectively lost.

At time t3, the original PWM signal transitions from a logic high state to a logic low state. In order to compensate for the current portion removed during the interval from t1 to t2, the system controller 150 extends the trailing edge of the PWM signal. As shown in the first row, the PWM signal remains high until time t4, thereby increasing the effective on-time of the PWM pulse by approximately the deglitch time interval.

By extending the PWM pulse width from t3 to t4, the system controller 150 restores the average LED current that would otherwise have been reduced due to the leading-edge suppression. In this manner, overshoot reduction and dimming accuracy are achieved simultaneously.

In some embodiments, cancellation of dimming error introduced by the deglitch operation is performed according to a timing algorithm executed by the system controller 150. More particularly, a rising edge (e.g., the edge at t1 shown in FIG. 15) of the deglitch time pulse is detected when the pulse crosses a defined threshold voltage, and the corresponding time instant (t1) is stored. A falling edge (e.g., the edge at t2 shown in FIG. 15) of the deglitch time pulse is then detected when it crosses the same threshold voltage. A time difference (t2-t1) between the rising edge and the falling edge is calculated. The time difference corresponds to the pulse width of the deglitch time signal shown in FIG. 15. The calculated pulse width is then used to delay a falling edge of the PWM signal, thereby extending the PWM on-time by approximately the duration of the deglitch interval. In this manner, a current component lost due to leading-edge deglitching is substantially recovered, thereby improving dimming accuracy while maintaining overshoot suppression.

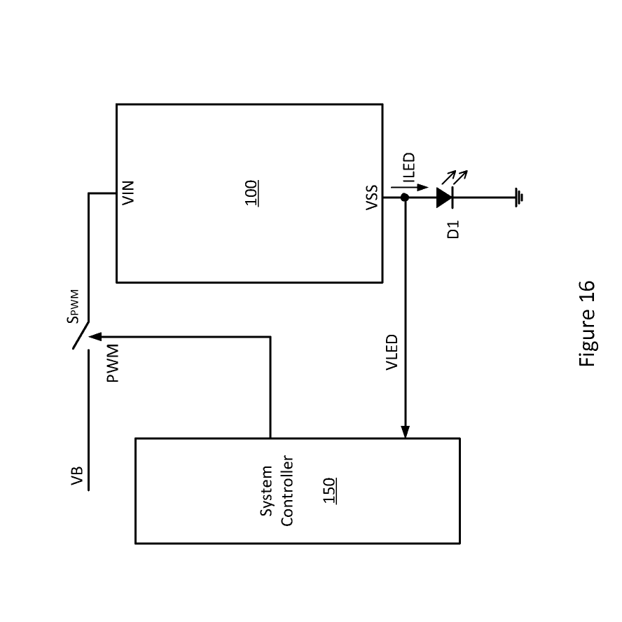

FIG. 16 illustrates a block diagram of a second alternative implementation of the light emitting diode system shown in FIG. 1 in accordance with various embodiments of the present disclosure. The configuration of FIG. 16 is similar to that of FIG. 1 except that the voltage VLED across the light emitting diode D1 is monitored by the system controller 150.

As shown in FIG. 16, the PWM switch S_{PWM}, the integrated circuit 100, and the light emitting diode D1 are coupled in series between the power source VB and ground. The system controller 150 is configured to generate a PWM signal to control the PWM switch S_{PWM}, thereby adjusting the average LED current ILED in accordance with a power PWM dimming technique.

In this embodiment, instead of receiving a dedicated deglitch time signal from the integrated circuit 100, the system controller 150 directly detects the voltage across the light emitting diode D1. During a PWM turn-on event, the integrated circuit 100 suppresses the leading-edge portion of the load current to mitigate overshoot. This suppression causes a temporary delay between the rising edge of the PWM signal and the establishment of the LED current, which is reflected in the voltage VLED across the light emitting diode D1.

By analyzing the timing relationship between the PWM signal and the detected VLED signal, the system controller 150 determines an interval corresponding to the duration of current suppression. In other words, the system controller 150 estimates how much LED current has been effectively removed in order to overcome the overshoot. Based on this analysis, the system controller 150 extends the trailing edge of the PWM signal by an amount corresponding to the duration of current suppression. By extending the trailing edge of the PWM pulse, the system controller 150 compensates for the current portion lost during the overshoot suppression period. As a result, the average LED current is restored to its intended value while maintaining reduced overshoot. Accordingly, the embodiment of FIG. 16 achieves overshoot reduction and dimming compensation without requiring a dedicated deglitch time output signal from the integrated circuit 100, thereby providing a flexible and system-level implementation.

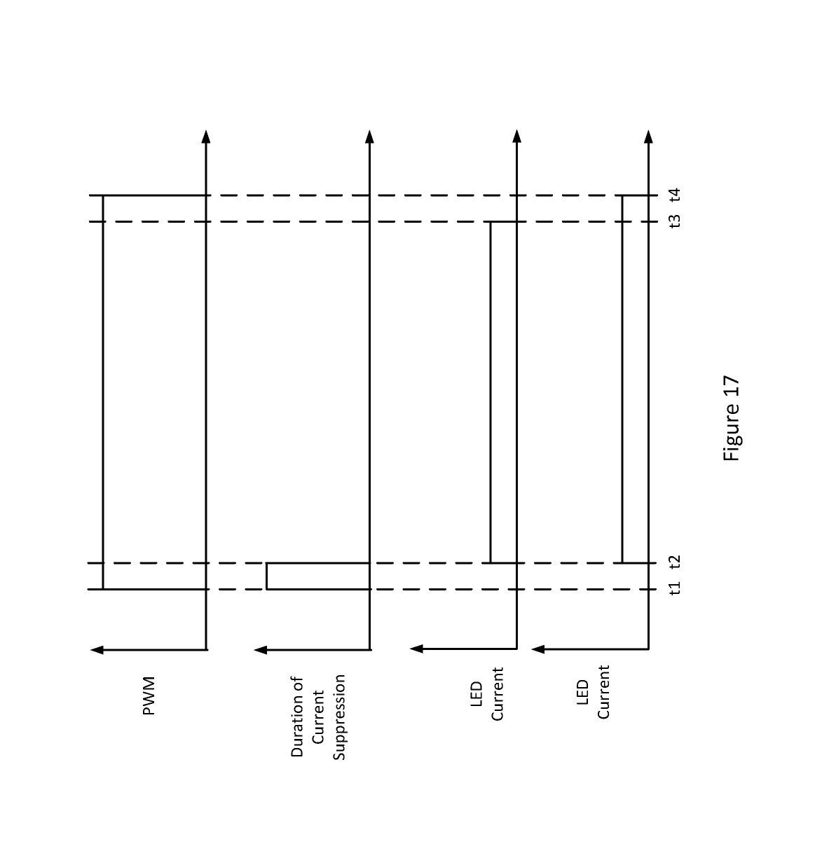

FIG. 17 illustrates various signals associated with the light emitting diode system shown in FIG. 16 in accordance with various embodiments of the present disclosure. The horizontal axis represents time. There are four rows. The first row illustrates the PWM signal generated by the system controller 150. The second row represents a duration during which the leading-edge portion of the load current is suppressed. The third row illustrates the LED current when compensation for the lost current portion is not employed. The fourth row illustrates the LED current when the compensation control scheme of FIG. 16 is employed.

At time t1, the PWM signal transitions from a logic low state to a logic high state. In response to this transition, the integrated circuit 100 suppresses the leading-edge portion of the load current to mitigate overshoot. As represented in the second row, a time interval extends from t1 to t2. During this interval, the LED current is held substantially at zero.

After time t2, the current suppression interval ends and the load current is allowed to establish. The LED current begins to increase toward its regulated value. However, because the current was suppressed during the interval from t1 to t2, a portion of the LED current corresponding to this duration is effectively lost.

At time t3, the original PWM signal transitions from a logic high state to a logic low state. If no compensation is applied, as shown in the third row, the effective on-time of the LED current remains shortened by the interval from t1 to t2, resulting in reduced average LED current and dimming inaccuracy. In contrast, when the control scheme of FIG. 16 is employed, the system controller 150 determines the duration of the current suppression (e.g., by analyzing the timing relationship between the PWM signal and the voltage VLED across the light emitting diode D1). Based on this determination, the system controller 150 extends the trailing edge of the PWM signal. As shown in the fourth row, the PWM signal remains in the logic high state until time t4, thereby extending the pulse width by approximately the duration from t1 to t2.

In some embodiments, the duration from t1 to t2 is equal to the duration from t3 to t4. By extending the trailing edge from t3 to t4, the system controller 150 compensates for the current portion removed during the leading-edge suppression interval. Consequently, the desired average LED current is restored while maintaining reduced overshoot at startup.

In some embodiments, the system controller 150 determines the deglitch time (from t1 to t2 shown in FIG. 17) by measuring a timing difference between a rising edge of the PWM signal and a corresponding rising transition of the voltage VLED shown in FIG. 16. More particularly, the system controller 150 detects a rising edge of the VLED pulse when VLED crosses a defined threshold voltage, and calculates a time difference between the rising edge of the PWM signal and the detected rising edge of VLED. The calculated time difference corresponds to the deglitch time during which the leading-edge portion of the LED current was suppressed (duration of current suppression shown in FIG. 17). The system controller 150 then delays a falling edge of the PWM signal by approximately the deglitch time, thereby extending the effective PWM on-time. In this manner, the LED current component lost during the deglitch interval is substantially recovered while maintaining reduced overshoot.

It should be appreciated that the three control schemes described herein, namely (i) employing an additional UVLO circuit to delay establishment of the load current until VINLED reaches a sufficient level, (ii) extending a trailing edge of a PWM signal by a system controller based on a deglitch time signal generated by the integrated circuit 100, and (iii) extending a trailing edge of the PWM signal by the system controller based on detecting a voltage across the light emitting diode (e.g., VLED across D1), are not limited to the specific system configuration described with respect to FIGS. 10-17. These control methods are equally applicable to the LED driver implementations shown in FIGS. 5, 6, and 8. In particular, the overshoot suppression and corresponding compensation techniques may be combined with any of the multi-path reference current architectures or current subtraction structures disclosed herein. Accordingly, the inventive concepts relating to UVLO-based suppression and PWM timing compensation may be implemented in various LED driver topologies without departing from the spirit and scope of the present disclosure.

Throughout this disclosure, the term ‘overshoot reduction circuit’ may refer to any circuit configured to suppress or mitigate leading-edge overshoot, including but not limited to the PWM deglitch circuit 208, the undervoltage lockout circuits 204 and/or 205, the reference current subtraction circuit 802, and/or functionality implemented by the system controller 150.

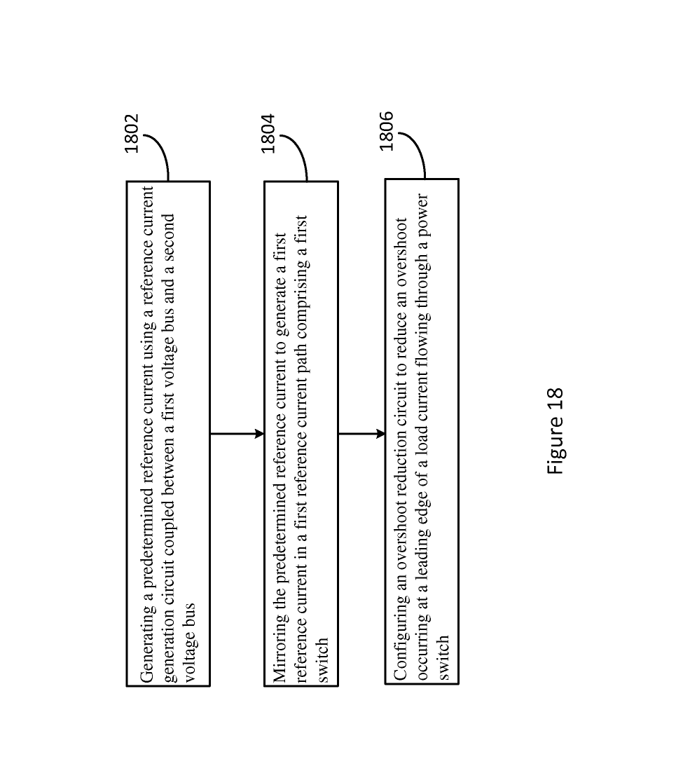

FIG. 18 illustrates a flow chart of a method for controlling the light emitting diode systems shown in FIGS. 10, 13 and 16 in accordance with various embodiments of the present disclosure. This flowchart shown in FIG. 18 is merely an example, which should not unduly limit the scope of the claims. One of ordinary skill in the art would recognize many variations, alternatives, and modifications. For example, various steps illustrated in FIG. 18 may be added, removed, replaced, rearranged and repeated.

At step 1802, a predetermined reference current is generated using a reference current generation circuit coupled between a first voltage bus and a second voltage bus.

At step 1804, the predetermined reference current is mirrored to generate a first reference current in a first reference current path comprising a first switch.

At step 1806, an overshoot reduction circuit is configured to reduce an overshoot occurring at a leading-edge of a load current flowing through a power switch.

The method further comprises mirroring the first reference current to generate the load current flowing through the power switch, wherein the overshoot reduction circuit comprises an undervoltage lockout unit, and wherein the undervoltage lockout unit is configured to reduce the overshoot occurring at the leading-edge of the load current flowing through the power switch.

The overshoot reduction circuit further comprises a second current mirror and a second amplifier.

A PWM deglitch circuit comprises a first inverter configured to receive a reference voltage signal proportional to the predetermined reference current; and a second inverter having an input connected to an output of the first inverter and an output configured to generate a first control signal applied to a gate of the first switch; and the reference current generation circuit comprises: a first p-type transistor and a resistor connected in series between the first voltage bus and the second voltage bus; and a first amplifier having an inverting input configured to receive a bandgap reference, a non-inverting input connected to a common node of the first p-type transistor and the resistor, and an output connected to a gate of the first p-type transistor and a gate of a second p-type transistor.

The first reference current path comprises the second p-type transistor and the first switch connected in series, and wherein the first p-type transistor and the second p-type transistor form a first current mirror through which the predetermined reference current is mirrored to generate the first reference current in the first reference current path.

The second current mirror comprises: a first n-type transistor connected in series with the first switch; and a second n-type transistor is connected in series with the power switch, wherein through the second current mirror, the first reference current is mirrored to generate the load current flowing through the power switch; and the second amplifier has an inverting input connected to a drain of the first n-type transistor, a non-inverting input connected to a drain of the second n-type transistor, and an output connected to a gate of the first n-type transistor and a gate of the second n-type transistor.

The method further comprises configuring a system controller to generate a PWM signal to control a PWM switch coupled in series with the power switch, configuring a PWM deglitch circuit to generate a deglitch time signal that removes a leading-edge portion of the load current flowing through the power switch, and based on the deglitch time signal, configuring the system controller to extend a trailing edge of the PWM signal to compensate for removal of the leading-edge portion of the load current, wherein the PWM deglitch circuit and the system controller are configured as the overshoot reduction circuit.

The method further comprises configuring a system controller to generate a PWM signal to control a PWM switch coupled in series with the power switch, configuring the system controller to detect removal of a leading-edge portion of the load current, and configuring the system controller to extend a trailing edge of the PWM signal to compensate for the removal of the leading-edge portion of the load current, wherein the system controller is configured as the overshoot reduction circuit configured to reduce the overshoot occurring at the leading-edge of the load current flowing through the power switch.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. An apparatus comprising:
a reference current generation circuit coupled between a first voltage bus and a second voltage bus, wherein the reference current generation circuit is configured to generate a predetermined reference current;
a first reference current path comprising a first switch, wherein the predetermined reference current is configured to be mirrored to generate a first reference current in the first reference current path;
a load current path comprising a power switch; and
an overshoot reduction circuit configured to reduce an overshoot occurring at a leading-edge of a load current flowing through the power switch.

2. The apparatus of claim 1, wherein:
the power switch is configured to be coupled to a power source through a plurality of light emitting diodes connected in series.

3. The apparatus of claim 1, wherein:
the reference current generation circuit comprises:
a first p-type transistor and a resistor connected in series between the first voltage bus and the second voltage bus; and
a first amplifier having an inverting input configured to receive a bandgap reference, a non-inverting input connected to a common node of the first p-type transistor and the resistor, and an output connected to a gate of the first p-type transistor; and
the first reference current path comprises a second p-type transistor, the first switch and a first n-type transistor connected in series, and wherein the first p-type transistor and the second p-type transistor form a first current mirror through which the predetermined reference current is mirrored to generate the first reference current in the first reference current path, and wherein:
the first n-type transistor and a second n-type transistor form a second current mirror through which the first reference current is mirrored to generate the load current flowing through the power switch; and
a gate of the first n-type transistor and a gate of the second n-type transistor are connected together and further connected to an output of a second amplifier having an inverting input connected to a drain of the first n-type transistor and a non-inverting input connected to a drain of the second n-type transistor, and wherein the power switch and the second n-type transistor are connected in series.

4. The apparatus of claim 3, wherein:
the overshoot reduction circuit comprises an undervoltage lockout unit, and wherein the undervoltage lockout unit is configured to receive a voltage on the drain of the second n-type transistor, and generate a signal to control the output of the second amplifier, and wherein:
the voltage on the drain of the second n-type transistor is compared with a predetermined reference;
the output of the second amplifier is pulled down to a logic low state when the voltage on the drain of the second n-type transistor is less than the predetermined reference; and
the logic low state at the output of the second amplifier is configured to reduce the overshoot occurring at the leading-edge of the load current flowing through the power switch.

5. The apparatus of claim 1, further comprising a pulse width modulation (PWM) deglitch circuit comprising:
a first inverter configured to receive a reference voltage signal proportional to the predetermined reference current; and
a second inverter having an input connected to an output of the first inverter and an output configured to generate a first control signal applied to a gate of the first switch.

6. The apparatus of claim 5, further comprising:
a system controller configured to generate a PWM signal to control a PWM switch connected in series with the power switch, wherein the system controller and the PWM deglitch circuit are configured as the overshoot reduction circuit configured to reduce the overshoot occurring at the leading-edge of the load current flowing through the power switch.

7. The apparatus of claim 6, wherein:
the PWM deglitch circuit is configured to generate a deglitch time signal that removes a leading-edge portion of the load current flowing through the power switch; and
based on the deglitch time signal, the system controller is configured to extend a trailing edge of the PWM signal to compensate for removal of the leading-edge portion of the load current.

8. The apparatus of claim 1, further comprising:
a system controller configured to generate a PWM signal to control a PWM switch connected in series with the power switch, wherein the system controller is configured as the overshoot reduction circuit configured to reduce the overshoot occurring at the leading-edge of the load current flowing through the power switch, and wherein the system controller is configured to detect removal of a leading-edge portion of the load current, and to extend a trailing edge of the PWM signal to compensate for the removal of the leading-edge portion of the load current.

9. The apparatus of claim 1, further comprising:
a low-dropout regulator having an input configured to receive an input voltage and an output configured to generate a bias voltage on the first voltage bus;
an undervoltage lockout circuit configured to receive the bias voltage and generate a control signal applied to a gate of the power switch; and
a bandgap reference circuit configured to receive the bias voltage, and generate a bandgap reference.

10. The apparatus of claim 1, further comprising:
a gate protection circuit connected between a gate of the power switch and the second voltage bus, wherein the gate protection circuit comprises a first resistor, a second resistor, a capacitor and a third n-type transistor, and wherein:
the third n-type transistor is connected between the gate of the power switch and the second voltage bus;
the capacitor and the first resistor are connected in series between the gate of the power switch and the second voltage bus; and
the second resistor is connected between the gate of the power switch and the second voltage bus.

11. The apparatus of claim 1, further comprising:
a startup circuit comprising a third current mirror comprising a fourth n-type transistor and a fifth n-type transistor, and a sixth p-type transistor, wherein:
the sixth p-type transistor and the fifth n-type transistor are connected in series between the first voltage bus and the second voltage bus;
the power switch and the fourth n-type transistor are connected in series between a third voltage bus and the second voltage bus; and
the predetermined reference current is configured to be mirrored to generate a current flowing through the sixth p-type transistor, and wherein:
the first voltage bus is configured to provide a bias voltage; and
the third voltage bus is configured to provide a drive voltage for a plurality of light emitting diodes.

12. A method comprising:
generating a predetermined reference current using a reference current generation circuit coupled between a first voltage bus and a second voltage bus;
mirroring the predetermined reference current to generate a first reference current in a first reference current path comprising a first switch; and
configuring an overshoot reduction circuit to reduce an overshoot occurring at a leading-edge of a load current flowing through a power switch.

13. The method of claim 12, further comprising:
mirroring the first reference current to generate the load current flowing through the power switch, wherein the overshoot reduction circuit comprises an undervoltage lockout unit, and wherein the undervoltage lockout unit is configured to reduce the overshoot occurring at the leading-edge of the load current flowing through the power switch.

14. The method of claim 13, wherein the overshoot reduction circuit further comprises a second current mirror and a second amplifier, and wherein:
a PWM deglitch circuit comprises:
a first inverter configured to receive a reference voltage signal proportional to the predetermined reference current; and
a second inverter having an input connected to an output of the first inverter and an output configured to generate a first control signal applied to a gate of the first switch;
the reference current generation circuit comprises:
a first p-type transistor and a resistor connected in series between the first voltage bus and the second voltage bus; and
a first amplifier having an inverting input configured to receive a bandgap reference, a non-inverting input connected to a common node of the first p-type transistor and the resistor, and an output connected to a gate of the first p-type transistor and a gate of a second p-type transistor;
the first reference current path comprises the second p-type transistor and the first switch connected in series, and wherein the first p-type transistor and the second p-type transistor form a first current mirror through which the predetermined reference current is mirrored to generate the first reference current in the first reference current path;
the second current mirror comprises:
a first n-type transistor connected in series with the first switch; and
a second n-type transistor is connected in series with the power switch, wherein through the second current mirror, the first reference current is mirrored to generate the load current flowing through the power switch; and
the second amplifier has an inverting input connected to a drain of the first n-type transistor, a non-inverting input connected to a drain of the second n-type transistor, and an output connected to a gate of the first n-type transistor and a gate of the second n-type transistor.

15. The method of claim 12, further comprising:
configuring a system controller to generate a PWM signal to control a PWM switch coupled in series with the power switch;
configuring a PWM deglitch circuit to generate a deglitch time signal that removes a leading-edge portion of the load current flowing through the power switch; and
based on the deglitch time signal, configuring the system controller to extend a trailing edge of the PWM signal to compensate for removal of the leading-edge portion of the load current, wherein the PWM deglitch circuit and the system controller are configured as the overshoot reduction circuit.

16. The method of claim 12, further comprising:
configuring a system controller to generate a PWM signal to control a PWM switch coupled in series with the power switch;
configuring the system controller to detect removal of a leading-edge portion of the load current; and
configuring the system controller to extend a trailing edge of the PWM signal to compensate for the removal of the leading-edge portion of the load current, wherein the system controller is configured as the overshoot reduction circuit configured to reduce the overshoot occurring at the leading-edge of the load current flowing through the power switch.

17. A system comprising:
a PWM switch, an integrated circuit and a light emitting diode coupled in series between a power source and ground; and
a system controller configured to control the PWM switch, wherein the integrated circuit comprises:
a reference current generation circuit coupled between a first voltage bus and a second voltage bus, wherein the reference current generation circuit is configured to generate a predetermined reference current;
a first reference current path comprising a first switch, wherein the predetermined reference current is configured to be mirrored to generate a first reference current in the first reference current path;
a load current path comprising a power switch; and
a PWM deglitch circuit configured to control the first switch so as to reduce an overshoot occurring at a leading-edge of a load current flowing through the power switch.

18. The system of claim 17, wherein:
the PWM deglitch circuit is configured to generate a deglitch time signal that removes a leading-edge portion of the load current flowing through the power switch; and
based on the deglitch time signal, the system controller is configured to extend a trailing edge of the PWM signal to compensate for removal of the leading-edge portion of the load current.

19. The system of claim 17, wherein:
the reference current generation circuit comprises:
a first p-type transistor and a resistor connected in series between the first voltage bus and the second voltage bus; and
a first amplifier having an inverting input configured to receive a bandgap reference, a non-inverting input connected to a common node of the first p-type transistor and the resistor, and an output connected to a gate of the first p-type transistor and a gate of a second p-type transistor; and
the first reference current path comprises the second p-type transistor and the first switch connected in series, and wherein the first p-type transistor and the second p-type transistor form a first current mirror through which the predetermined reference current is mirrored to generate the first reference current in the first reference current path.

20. The system of claim 17, further comprising:
a low-dropout regulator having an input configured to receive an input voltage and an output configured to generate a bias voltage on the first voltage bus;
an undervoltage lockout circuit configured to receive the bias voltage and generate a control signal applied to a gate of the power switch, wherein a current flowing through the power switch is approximately equal to a current flowing through the light emitting diode; and
a bandgap reference circuit configured to receive the bias voltage and generate a bandgap reference.
